(19) United States
(12) Patent Application Publication
(10) Pub. No.: US 2025/0031246 A1
(43) Pub. Date: Jan. 23, 2025

(54) METHOD AND APPARATUS FOR SIGNAL TRANSMISSION IN SIDELINK COMMUNICATION

(71) Applicant: Electronics and Telecommunications Research Institute, Daejeon (KR)

(72) Inventors: Hoi Yoon JUNG, Daejeon (KR); Sung Ik PARK, Daejeon (KR); Jung Sun UM, Daejeon (KR); Nam Ho HUR, Daejeon (KR)

(21) Appl. No.: 18/776,124

(22) Filed: Jul. 17, 2024

(30) Foreign Application Priority Data
Jul. 17, 2023 (KR) 10-2023-0092678
Sep. 6, 2023 (KR) 10-2023-0118468
Oct. 31, 2023 (KR) 10-2023-0148166
Jul. 8, 2024 (KR) 10-2024-0089675

(51) Int. Cl. H04W 74/0808; H04L 5/00; H04W 72/40

(52) U.S. Cl. CPC H04W 74/0808; H04L 5/0048; H04W 72/40

(57) ABSTRACT

Disclosed are signal transmission methods and apparatuses in sidelink communication. A method of a terminal may comprise: receiving sidelink (SL) configuration information from a base station; identifying cyclic prefix extension (CPE) information indicating one or more CPE start positions included in the SL configuration information; configuring a CPE based on the CPE information; and performing SL transmission including the CPE.

### CROSS-REFERENCE TO RELATED APPLICATIONS

This application claims priority to Korean Patent Applications No. 10-2023-0092678, filed on Jul. 17, 2023, No. 10-2023-0118468, filed on Sep. 6, 2023, No. 10-2023-0148166, filed on Oct. 31, 2023, and No. 10-2024-0089675, filed on Jul. 8, 2024, with the Korean Intellectual Property Office (KIPO), the entire contents of which are hereby incorporated by reference.

### BACKGROUND

### 1. Technical Field

The present disclosure relates to a signal transmission technique in a communication system, and more particularly, to a signal transmission technique based on a cyclic prefix extension (CPE) scheme in sidelink communication.

### 2. Related Art

With the advancement of information and communication technology, various wireless communication technologies are being developed. The representative wireless communication technologies may be long term evolution (LTE), LTE-advanced (LTE-A), new radio (NR), and the like specified as the 3^{rd} generation partnership project (3GPP) standards. The LTE and/or LTE-A may be 4^{th} generation (4G) communication technology. The NR may be a 5^{th} generation (5G) communication technology.

The 5G communication system (e.g., communication system supporting the NR) using a higher frequency band (e.g., a frequency band of 6 GHz or above) than a frequency band (e.g., a frequency band of 6 GHz or below) of the 4G communication system is being considered for processing of soaring wireless data after commercialization of the 4G communication system (e.g., communication system supporting the LTE and/or LTE-A). The 5G communication system may support enhanced Mobile BroadBand (eMBB), Ultra Reliable Low Latency Communication (URLLC), and/or Massive Machine Type Communication (mMTC).

The 5G communication system can support sidelink communication. In sidelink communication, communication can be performed between terminals. For example, a first terminal may transmit signals, information, and/or data to a second terminal, and the second terminal may receive the signals, information, and/or data from the first terminal. Channels for sidelink communication may be a physical sidelink broadcast channel (PSBCH), physical sidelink shared channel (PSSCH), physical sidelink control channel (PSCCH), and/or physical sidelink feedback channel (PSFCH).

In sidelink communication, a terminal can support consecutive transmissions of channels (e.g., signals). These channels can be transmitted consecutively according to a preconfigured interval (e.g., gap). However, if this preconfigured interval is occupied by another communication node (e.g., base station, terminal), the terminal cannot perform consecutive transmissions of the channels. Therefore, methods for configuring channels (e.g., methods for configuring signals) are needed to address the aforementioned issue.

Meanwhile, the above-described technologies are described to enhance the understanding of the background of the present disclosure, and they may include non-prior arts that are not already known to those of ordinary skill in the art.

### SUMMARY

The present disclosure for resolving the above-described problems is directed to providing a method and an apparatus for signal transmission based on a CPE scheme in sidelink communication.

A method of a terminal, according to exemplary embodiments of the present disclosure for achieving the above-described objective, may comprise: receiving sidelink (SL) configuration information from a base station; identifying cyclic prefix extension (CPE) information indicating one or more CPE start positions included in the SL configuration information; configuring a CPE based on the CPE information; and performing SL transmission including the CPE.

The configuring of the CPE based on the CPE information may comprise: in response to the CPE information indicating a plurality of CPE start positions, randomly selecting one CPE start position from among the plurality of CPE start positions; and configuring the CPE based on the one CPE start position.

The configuring of the CPE based on the CPE information may comprise: applying the CPE to a first symbol of a SL signal or SL channel, and the CPE may be located in one or two symbols before the first symbol.

The SL configuration information may include at least one of CPE information indicating one or more CPE start positions for sidelink-synchronization signal block (S-SSB) transmission, CPE information indicating one or more CPE start positions for physical sidelink feedback channel (PSFCH) transmission, or CPE information indicating one or more CPE start positions for physical sidelink control channel (PSCCH)/physical sidelink shared channel (PSSCH) transmission.

The performing of the SL transmission including the CPE may comprise: performing S-SSB transmission including the CPE determined based on one CPE start position among the one or more CPE start positions for S-SSB transmission.

The performing of the SL transmission including the CPE may comprise: performing PSFCH transmission including the CPE determined based on one CPE start position among the one or more CPE start positions for PSFCH transmission.

The CPE information indicating one or more CPE start positions for PSCCH/PSSCH transmission may include at least one of CPE information indicating one or more CPE start positions for PSCCH/PSSCH transmission for channel occupancy time (COT) initiation, or CPE information indicating one or more CPE start positions for PSCCH/PSSCH transmission within a COT.

The CPE information indicating one or more CPE start positions for PSCCH/PSSCH transmission for COT initiation may include at least one of a list of one or more CPE start positions for PSCCH/PSSCH transmission for COT initiation or information on a default CPE start position for PSCCH/PSSCH transmission for COT initiation.

The list may include the one or more CPE start positions for PSCCH/PSSCH transmission for COT initiation and a priority associated with the one or more CPE start positions for PSCCH/PSSCH transmission for COT initiation.

When the list of one or more CPE start positions for PSCCH/PSSCH transmission for COT initiation is configured to the terminal, the CPE may be configured based on one CPE start position among the one or more CPE start positions belonging to the list, and at least one of PSCCH transmission including the CPE or PSSCH transmission including the CPE may be performed for COT initiation.

When the list of one or more CPE start positions for PSCCH/PSSCH transmission for COT initiation is not configured to the terminal, and the default CPE start position for PSCCH/PSSCH transmission for COT initiation is configured to the terminal, the CPE may be configured based on the default CPE start position, and at least one of PSCCH transmission including the CPE or PSSCH transmission including the CPE may be performed for COT initiation.

The CPE information indicating one or more CPE start positions for PSCCH/PSSCH transmission within a COT may include at least one of a list of one or more CPE start positions for PSCCH/PSSCH transmission within a COT or information on a default CPE start position for PSCCH/PSSCH transmission within a COT.

When the list of one or more CPE start positions for PSCCH/PSSCH transmission within a COT is configured to the terminal, the CPE may be configured based on one CPE start position among the one or more CPE start positions belonging to the list, and at least one of PSCCH transmission including the CPE or PSSCH transmission including the CPE may be performed within a COT.

When the list of one or more CPE start positions for PSCCH/PSSCH transmission within a COT is not configured to the terminal, and the default CPE start position for PSCCH/PSSCH transmission within a COT is configured to the terminal, the CPE may be configured based on the default CPE start position, and at least one of PSCCH transmission including the CPE or PSSCH transmission including the CPE may be performed within a COT.

A terminal, according to exemplary embodiments of the present disclosure for achieving the above-described objective, may comprise at least one processor, and the at least processor causes the terminal to perform: receiving sidelink (SL) configuration information from a base station; identifying cyclic prefix extension (CPE) information indicating one or more CPE start positions included in the SL configuration information; configuring a CPE based on the CPE information; and performing SL transmission including the CPE.

In the configuring of the CPE based on the CPE information, the at least one processor may cause the terminal to perform: in response to the CPE information indicating a plurality of CPE start positions, randomly selecting one CPE start position from among the plurality of CPE start positions; and configuring the CPE based on the one CPE start position.

In the configuring of the CPE based on the CPE information, the at least one processor may cause the terminal to perform: applying the CPE to a first symbol of a SL signal or SL channel, and the CPE may be located in one or two symbols before the first symbol.

The SL configuration information may include at least one of CPE information indicating one or more CPE start positions for sidelink-synchronization signal block (S-SSB) transmission, CPE information indicating one or more CPE start positions for physical sidelink feedback channel (PSFCH) transmission, or CPE information indicating one or more CPE start positions for physical sidelink control channel (PSCCH)/physical sidelink shared channel (PSSCH) transmission.

In the performing of the SL transmission including the CPE, the at least one processor may cause the terminal to perform: performing S-SSB transmission including the CPE determined based on one CPE start position among the one or more CPE start positions for S-SSB transmission.

The CPE information indicating one or more CPE start positions for PSCCH/PSSCH transmission may include at least one of CPE information indicating one or more CPE start positions for PSCCH/PSSCH transmission for channel occupancy time (COT) initiation, or CPE information indicating one or more CPE start positions for PSCCH/PSSCH transmission within a COT.

According to the present disclosure, a terminal can configure a cyclic prefix extension (CPE) for SL transmission and perform SL transmission that includes the CPE. When SL transmission that includes the CPE is performed, a time interval between SL transmissions can be reduced. Consequently, the issue of a time interval between SL transmissions being occupied by another communication node (e.g., base stations, other terminals), preventing the next SL transmission from being performed, can be resolved. As consecutive SL transmissions can be successfully performed, the performance of the communication network can be improved.

### BRIEF DESCRIPTION OF DRAWINGS

FIG. 1 is a conceptual diagram illustrating a first exemplary embodiment of a communication network.

FIG. 2 is a block diagram illustrating a first exemplary embodiment of a communication node constituting a communication network.

FIG. 3 is a conceptual diagram illustrating a first exemplary embodiment of a system frame in a communication network.

FIG. 4 is a conceptual diagram illustrating a first exemplary embodiment of a subframe in a communication network.

FIG. 5 is a conceptual diagram illustrating a first exemplary embodiment of a slot in a communication network.

FIG. 6 is a conceptual diagram illustrating a first exemplary embodiment of time-frequency resources in a communication network.

FIG. 7 is a conceptual diagram illustrating a first exemplary embodiment of configuration of a resource pool, SL signals, and SL channels within an SL bandwidth part (BWP).

FIG. 8 is a conceptual diagram illustrating a first exemplary embodiment of SL resources.

FIG. 9 is a conceptual diagram illustrating exemplary embodiments of a method of configuring signals in a communication network.

FIG. 10 is another conceptual diagram illustrating exemplary embodiments of a method of configuring signals in a communication network.

FIG. 11 is yet another conceptual diagram illustrating exemplary embodiments of a method of configuring signals in a communication network.

FIG. 12 is a flowchart illustrating exemplary embodiments of a method for configuring an extended CP in a communication network.

FIG. 13 is a sequence chart illustrating exemplary embodiments of a method for configuring an extended CP in a communication network.

FIG. 14 is another flowchart illustrating exemplary embodiments of a method for configuring an extended CP in a communication network.

FIG. 15 is yet another flowchart illustrating exemplary embodiments of a method for configuring an extended CP in a communication network.

FIG. 16 is another sequence chart illustrating exemplary embodiments of a method for configuring an extended CP in a communication network.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

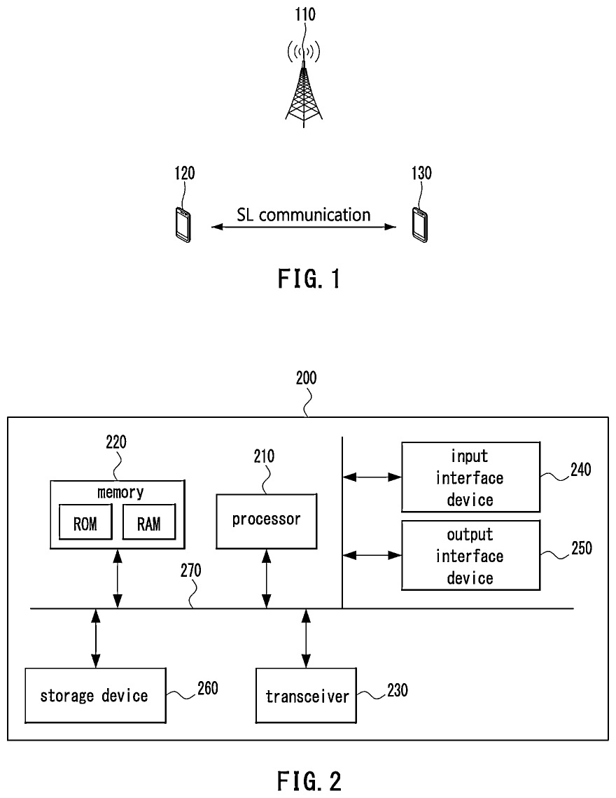

FIG. 1 is a conceptual diagram illustrating a first exemplary embodiment of a communication network.

Referring to FIG. 1, a base station 110 may support cellular communication (e.g., long term evolution (LTE), LTE-advance (LTE-A), LTE-A Pro, LTE-unlicensed (LTE-U), new radio (NR), and NR-unlicensed (NR-U) specified as the 3^{rd} generation partnership project (3GPP) standards), or the like. The base station 110 may support multiple-input multiple-output (MIMO) (e.g., single-user MIMO (SU-MIMO), multi-user MIMO (MU-MIMO), massive MIMO, etc.), coordinated multipoint (COMP), carrier aggregation (CA), or the like. A first terminal 120 and a second terminal 130 may perform sidelink communication.

The sidelink communication may be performed based on a mode 1 or mode 2. When the mode 1 is used, sidelink communication between the first terminal 120 and the second terminal 130 may be performed using resource(s) allocated by the base station 110. When the mode 2 is used, sidelink communication between the first terminal 120 and the second terminal 130 may be performed using resource(s) selected by the first terminal 120 or the second terminal 130.

The communication node (i.e., base station, terminal, etc.) constituting the communication network described above may support a code division multiple access (CDMA) based communication protocol, a wideband CDMA (WCDMA) based communication protocol, a time division multiple access (TDMA) based communication protocol, a frequency division multiple access (FDMA) based communication protocol, a single carrier-FDMA (SC-FDMA) based communication protocol, an orthogonal frequency division multiplexing (OFDM) based communication protocol, an orthogonal frequency division multiple access (OFDMA) based communication protocol, or the like.

Among the communication nodes, the base station may be referred to as a Node B, evolved Node B, 5G Node B (gNodeB), base transceiver station (BTS), radio base station, radio transceiver, access point, access node, transmission/reception point (Tx/Rx Point), or the like. Among the communication nodes, the terminal may be referred to as a user equipment (UE), access terminal, mobile terminal, station, subscriber station, portable subscriber station, mobile station, node, device, or the like. The communication node may have the following structure.

FIG. 2 is a block diagram illustrating a first exemplary embodiment of a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Hereinafter, operation methods of a communication node in a communication network will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a first terminal (e.g., transmitting terminal) is described, a corresponding second terminal (e.g., receiving terminal) may perform an operation corresponding to the operation of the first terminal. Conversely, when an operation of the second terminal is described, the corresponding first terminal may perform an operation corresponding to the operation of the second terminal.

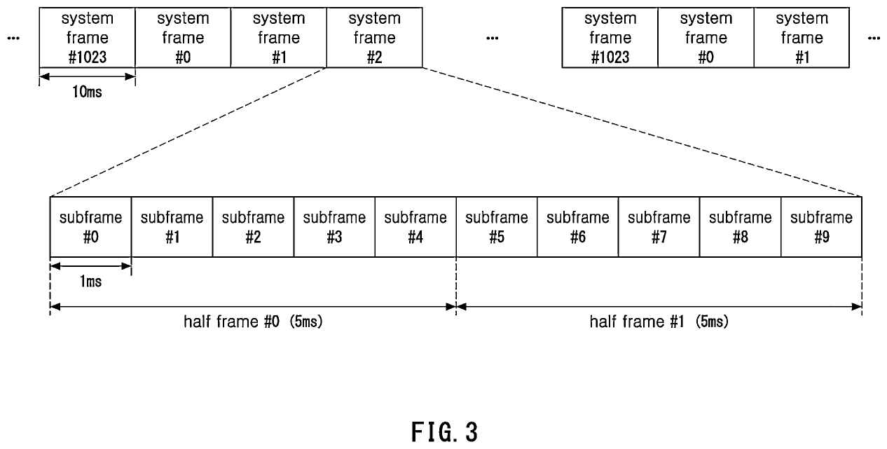

FIG. 3 is a conceptual diagram illustrating a first exemplary embodiment of a system frame in a communication network.

Referring to FIG. 3, time resources in a communication network may be divided into frames. For example, system frames each of which has a length of 10 milliseconds (ms) may be configured consecutively in the time domain of the communication network. System frame numbers (SFNs) may be set to #0 to #1023. In this case, 1024 system frames may be repeated in the time domain of the communication network. For example, an SFN of a system frame after the system frame #1023 may be set to #0.

One system frame may comprise two half frames, and the length of one half frame may be 5 ms. A half frame located in a starting region of a system frame may be referred to as a ‘half frame #0’, and a half frame located in an ending region of the system frame may be referred to as a ‘half frame #1’. The system frame may include 10 subframes, and the length of one subframe may be 1 ms. 10 subframes within one system frame may be referred to as ‘subframes #0 to #9’.

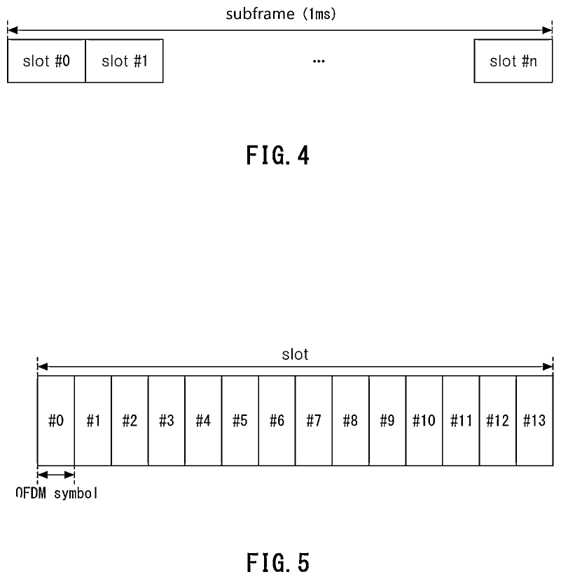

FIG. 4 is a conceptual diagram illustrating a first exemplary embodiment of a subframe in a communication network.

Referring to FIG. 4, one subframe may include n slots, and n may be a natural number. Accordingly, one subframe may be composed of one or more slots.

FIG. 5 is a conceptual diagram illustrating a first exemplary embodiment of a slot in a communication network.

Referring to FIG. 5, one slot may comprise one or more symbols. One slot shown in FIG. 5 may be composed of 14 symbols. Here, the length of the slot may vary depending on the number of symbols included in the slot and the length of the symbol. Alternatively, the length of the slot may vary according to a numerology. When a subcarrier spacing is 15 kHz (e.g., μ=0), the length of the slot may be 1 ms. In this case, one system frame may include 10 slots. When the subcarrier spacing is 30 kHz (e.g., μ=1), the length of the slot may be 0.5 ms. In this case, one system frame may include 20 slots.

When the subcarrier spacing is 60 kHz (e.g., μ=2), the length of the slot may be 0.25 ms. In this case, one system frame may include 40 slots. When the subcarrier spacing is 120 kHz (e.g., μ=3), the length of the slot may be 0.125 ms. In this case, one system frame may include 80 slots. When the subcarrier spacing is 240 kHz (e.g., μ=4), the length of the slot may be 0.0625 ms. In this case, one system frame may include 160 slots.

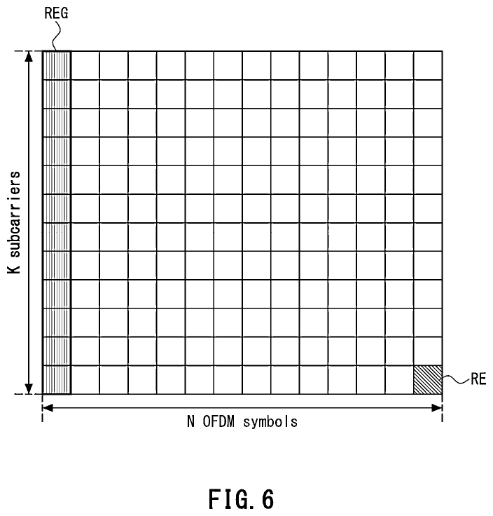

FIG. 6 is a conceptual diagram illustrating a first exemplary embodiment of time-frequency resources in a communication network.

Referring to FIG. 6, a resource configured with one OFDM symbol in the time domain and one subcarrier in the frequency domain may be defined as a ‘resource element (RE)’. Resources configured with one OFDM symbol in the time domain and K subcarriers in the frequency domain may be defined as a ‘resource element group (REG)’. One REG may include K REs. The REG may be used as a basic unit of resource allocation in the frequency domain. K may be a natural number. For example, K may be 12. N may be a natural number. N in the slot shown in FIG. 5 may be 14, and N in the slot shown in FIG. 6 may be 7. The N OFDM symbols may be used as a basic unit of resource allocation in the time domain.

Methods for transmitting and receiving data in a communication network will be described. In downlink communication, downlink data may be transmitted through a physical downlink shared channel (PDSCH). In uplink communication, uplink data may be transmitted through a physical uplink shared channel (PUSCH). In the present disclosure, a PDSCH may refer to downlink data or a resource in which the downlink data is transmitted and received, and a PUSCH may refer to uplink data or a resource in which the uplink data is transmitted and received. A base station may transmit downlink control information (DCI) including configuration information (e.g., resource allocation information, scheduling information) of a PDSCH on a physical downlink control channel (PDCCH). In the present disclosure, a PDCCH may refer to a DCI (e.g., control information) or a resource in which the DCI is transmitted.

A terminal may receive the DCI on the PDCCH and identify the configuration information of the PDSCH included in the DCI. For example, the configuration information of the PDSCH may include time domain resource assignment (TDRA), frequency domain resource assignment (FDRA), and/or modulation and coding scheme (MCS) information. The TDRA may indicate a resource region of the PDSCH in the time domain. The FDRA may indicate a resource region of the PDSCH in the frequency domain. The MCS information may indicate an MCS level or MCS index.

Sidelink (SL) communication methods in the communication network will be described. The SL communication may be performed in a licensed band and/or an unlicensed band. The SL communication in an unlicensed band may be referred to as sidelink-unlicensed (SL-U) communication or unlicensed-sidelink (U-SL) communication. SL resources may be used for transmission of SL signals and/or channels. The SL resources may be configured on a resource pool basis. A resource pool may be referred to as an SL resource pool. The resource pool may include a Tx resource pool and/or an Rx resource pool. The Tx resource pool may be used for SL transmission, and the Rx resource pool may be used for SL reception. The Tx resource pool and the Rx resource pool may be distinguished from each other. The Tx resource pool and the Rx resource pool may be configured independently. In the present disclosure, ‘SL transmission’ may refer to one of ‘unicast SL transmission’, ‘groupcast SL transmission’, ‘multicast SL transmission’, or ‘broadcast SL transmission’.

In the time domain, a resource pool may include one or more slots, and in the frequency domain, a resource pool may include one or more subchannels. One subchannel may include NPRB physical resource blocks (PRBs). NPRB may be one of 10, 12, 15, 20, 25, 50, 75, or 100. The resource pool may be configured periodically. For example, the resource pool may be configured at a periodicity of 10240 milliseconds (ms) in the time domain. Some slots among all slots belonging to a period corresponding to the periodicity of 10240 ms may be configured as the resource pool. Depending on a time division duplex (TDD) configuration, slot(s) including a downlink (DL) symbol may not be configured as the resource pool. Slot(s) including resources in which a sidelink-synchronization signal block (S-SSB) can be transmitted may not be configured as the resource pool. Slot(s) configurable as the resource pool may be defined by a bitmap. In other words, the bitmap may indicate slot(s) configurable as the resource pool.

An SL channel may be used for transmission and reception of traffic (e.g., data), management information, and/or control information (e.g., control information related to scheduling) related to SL services. The SL channel may include a physical sidelink broadcast channel (PSBCH), a physical sidelink shared channel (PSSCH), a physical sidelink control channel (PSCCH), and/or a physical sidelink feedback channel (PSFCH). The SL signal may include a synchronization signal (e.g., sidelink-primary synchronization signal (S-PSS), sidelink-secondary synchronization signal (S-SSS)) and/or a reference signal (e.g., demodulation reference signal (DMRS), channel state information-reference signal (CSI-RS), phase tracking (PT)-RS, and positioning reference signal (PRS)).

The PSSCH may be a channel used for transmission and reception of a transport block (TB), data, and/or traffic. The PSCCH may be a channel used for transmitting and receiving control information. The PSFCH may be a channel used for transmission and reception of a hybrid automatic repeat request (HARQ) feedback indicating a reception status of the PSSCH. The S-SSB may include at least one of the PSBCH, S-PSS, or S-SSS. The S-SSB may further include a DMRS. Synchronization between terminals may be performed using the synchronization signals (e.g., S-PSS and/or S-SSS).

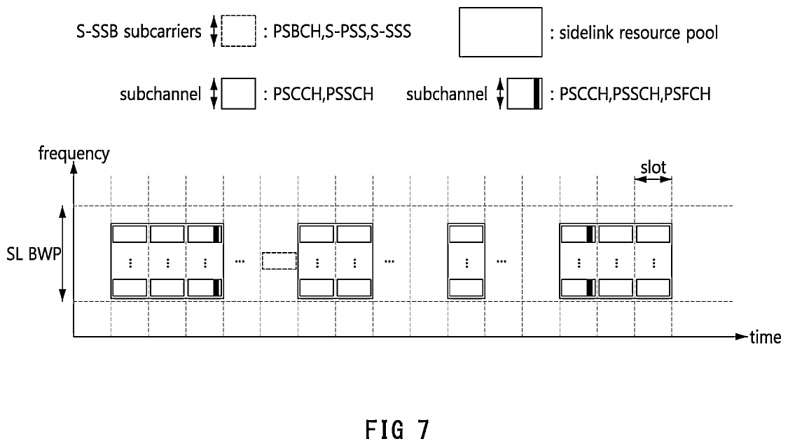

FIG. 7 is a conceptual diagram illustrating a first exemplary embodiment of configuration of a resource pool, SL signals, and SL channels within an SL bandwidth part (BWP).

Referring to FIG. 7, a resource pool may include one or more slots excluding slot(s) that do not meet configuration conditions of the resource pool and/or slot(s) not indicated by a bitmap among a plurality of slots. Non-consecutive slots in the time domain may be interpreted as consecutive within the resource pool. In other words, even when slots configured as the resource pool are not consecutive, indexes of the slots within the resource pool may be consecutive.

In the present disclosure, an SL resource (e.g., SL transmission resource) may refer to a resource within the resource pool. The SL resource may refer to a resource for transmission of an SL signal and/or SL channel. In the present disclosure, signal transmission may refer to transmission of an SL signal and/or SL channel, and signal reception may refer to reception of an SL signal and/or SL channel. ‘Signal’ may be interpreted as ‘signal’ or ‘signal+channel’, and ‘channel’ may be interpreted as ‘channel’ or ‘channel+signal’. ‘SL signal/channel’ may be interpreted as ‘SL signal’, ‘SL channel’, or ‘SL signal+SL channel’.

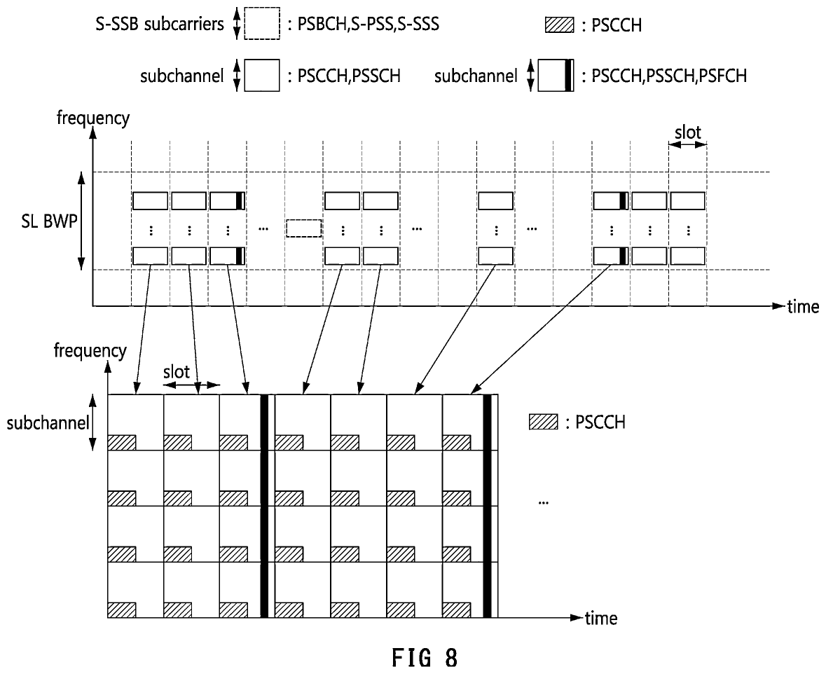

FIG. 8 is a conceptual diagram illustrating a first exemplary embodiment of SL resources.

Referring to FIG. 8, a basic transmission unit of an SL signal/channel in the time domain may be one slot, and a basic transmission unit of an SL signal/channel in the frequency domain may be one subchannel. A transmission resource of an SL signal/channel may include one or more slots and/or one or more subchannels. The transmission resource may include a PSCCH and/or a PSSCH. In addition, the transmission resource may include a PSFCH. A slot (e.g., position of the slot) including a PSFCH may be predefined. The slot including a PSFCH may be referred to as a PSFCH slot. A configuration condition of a PSFCH slot in a licensed band may be different from a configuration condition of a PSFCH slot in an unlicensed band. A transmission operation of a HARQ feedback in a PSFCH slot of a licensed band may be different from a transmission operation of a HARQ feedback in a PSFCH slot of an unlicensed band. Configuration information of an SL channel actually transmitted in a transmission resource may be transmitted through signaling (e.g., RRC message, SCI). The configuration information of the SL channel may include frequency resource information (e.g., position of a frequency resource region), time resource information (e.g., position of a time resource region), and the like.

SL resources may be allocated based on a mode 1 or mode 2. The mode 1 may be referred to as a resource allocation (RA)-mode 1, and the mode 2 may be referred to as an RA-mode 2. When the RA-mode 1 is used, a base station may transmit a DCI (e.g., SL grant) including SL resource allocation information to a terminal, and the terminal may perform SL communication using the SL resources allocated by the base station. When the RA-mode 2 is used, the terminal may perform a resource sensing operation within the resource pool, perform a resource selection operation for resources sensed by the resource sensing operation, and perform SL communication using resources selected by the resource selection operation.

In the RA-mode 1, when transmission data occurs, the terminal may transmit a scheduling request (SR) for the transmission data to the base station, and the base station may allocation resources (e.g., SL resources) to the terminal based on the SR by using a dynamic grant (DG). In the RA-mode 1, the base station may allocate periodic resources to the terminal in a semi-static scheme, and the terminal may perform SL communication using the periodic resources allocated by the base station.

The periodic resources allocated in the semi-static scheme may be configured grant (CG) resources. The base station may transmit allocation information of CG resources to the terminal. The allocation information of the CG resources may include at least one of position information of the CG resources, time resource information of the CG resources, frequency resource information of the CG resources, or periodicity information of the CG resources. According to a release procedure or deactivation procedure of CG resources, a CG scheme may be classified into CG-Type 1 and CG-Type 2. In the CG-Type 1, CG resources may be released by RRC signaling. In the CG-Type 2, CG resources may be deactivated by DCI signaling.

In the RA-mode 2, the terminal may perform a resource sensing operation during a sensing window, select resource(s) that satisfy predefined conditions among resources sensed by the resource sensing operation, and transmit an SL signal/channel using the selected resource(s). The resource sensing/selection methods according to the RA-mode 2 may be classified into a dynamic scheme and a semi-static scheme. According to the semi-static scheme, specific time resources may be occupied. The dynamic scheme and the semi-static scheme may be distinguished depending on a time of selecting new resources. When the dynamic scheme is used, the terminal may select resources for TB transmission every time it wants to transmit a new TB. The TB transmission may include ‘new TB transmission (e.g., initial TB transmission)’ and/or ‘TB retransmission’. One or more resources (e.g., one or more transmission resources) may be used, occupied, and/or reserved for TB transmission.

When the semi-static scheme is used, a counter value of TB transmission may be 0 during a specific time (e.g., resource reservation interval (RRI)). Alternatively, when the semi-static scheme is used, a new transmission resource may be selected under a specific condition. The counter value of TB transmission may be selected randomly. The selected counter value may be decreased by 1 when one TB transmission (e.g., new TB transmission and/or TB retransmission) is completed. When the semi-static scheme is used, the terminal may continue to occupy the selected resource during a specific time. In other words, the terminal may continue to use the selected resource during the specific time. The specific time may mean a time that the terminal can exclusively occupy. The specific time may be defined as RRI.

The base station may signal an RRI list to the terminal. The RRI list may include up to 16 RRIs (e.g., up to 16 RRI values). The signaling may be at least one of system information (SI) signaling, RRC signaling, MAC CE signaling, or PHY signaling. The terminal may receive the RRI list from the base station, select one RRI among RRIs belonging to the RRI list, and use a selected resource (e.g., selected transmission resource) during the selected RRI. The terminal may occupy consecutive resources during the RRI. The consecutive resources may be configured in a logical resource region for SL.

A first terminal may transmit an SCI including information of the selected RRI to a second terminal. The second terminal may receive the SCI from the first terminal and identify the RRI selected by the first terminal based on an information element included in the SCI. The second terminal may not select a resource (e.g., resource selected by the first terminal) during the RRI indicated by the SCI. The information on the resource selected by the first terminal may be included in the SCI.

When the RA-mode 2 is used, a resource sensing window and/or a resource selection window may be configured. The resource sensing window may be referred to as a sensing window (SSW), and a resource sensing operation may be performed within the SSW. The resource selection window may be referred to as a selection window (SLW), and a resource selection operation may be performed within the SLW. Resources used during the RRI (e.g., RRI value) indicated by the SCI may be identified by the resource sensing operation performed in the SSW.

The sidelink control information (SCI) may include scheduling information (e.g., scheduling information of a TB) and/or parameter(s) applicable to TB transmission. The parameter(s) applied to TB transmission may be used for demodulation/decoding of the TB at a receiving terminal. The SCI may be classified into a first-stage SCI (1^{st} SCI) and a second-state SCI (2^{nd} SCI). The first-stage SCI may be transmitted on a PSCCH, and the second-stage SCI may be transmitted on a PSSCH. The second-stage SCI may be associated with the first-stage SCI. The first-stage SCI may include scheduling information for initial TB transmission and/or scheduling information for TB retransmission. The second-stage SCI may include at least one of information on a PSSCH transmitting terminal, information on a PSSCH receiving terminal, HARQ feedback information, or retransmission information.

Y transmission resources including a slot in which the first-stage SCI is transmitted may be configured. Y may be a natural number. For example, Y may be 2 or 3. The first transmission resource among the Y transmission resources may be configured in the slot in which the first-stage SCI is transmitted. In other words, the first transmission resource among the Y transmission resources may be the slot in which the first-stage SCI is transmitted. The slot(s) in which (Y-1) transmission resources are configured may be defined by slot offset(s). The slot offset may be a positive integer. The maximum value of the slot offset may be 32.

The scheduled first transmission resource may include N_{subchannel} subchannels in the frequency domain. The first subchannel (e.g., start subchannel) among N_{subchannel} subchannels may be a subchannel through which the first-stage SCI is transmitted. N_{subchannel} may be a natural number. N_{subchannel} may be set to be equal to or less than the maximum number of subchannels configured by higher layer signaling. The first-stage SCI may include frequency resource information of the second transmission resource (e.g., information of N subchannel(s), information of a start subchannel among the N subchannel(s)) and/or frequency resource information of the third transmission resource (e.g., information of N subchannel(s), information on a start subchannel among the N subchannel(s)). The number N of subchannels of the second transmission resource may be the same as the number N_{subchannel} of subchannels of the first transmission resource. The number N of subchannels of the third transmission resource may be the same as the number N_{subchannel} of subchannels of the first transmission resource. The first transmission resource among the Y transmission resources may be a transmission resource for the first TB transmission (e.g., initial TB transmission). The remaining (Y-1) transmission resource(s) may be transmission resource(s) for TB retransmission.

The first-stage SCI may include one or more information elements defined in Table 1 below.

TABLE 1
Information elements

Priority: Priority of data or information transmitted on a PSSCH
Frequency resource assignment: information on subchannels of one
or two additional transmission resources
Time resource assignment: information on slot offset(s) of one or
two additional transmission resources other than the first-stage SCI
Resource reservation period: time period in which the same resource
is used
PSFCH overhead indicator: information indicating whether to transmit
a PSFCH. A receiving terminal may perform an operation of determining
a TB size (TBS) and/or an operation of identifying resource elements
(REs) used for PSSCH transmission based on the PSFCH overhead
indicator.
Second-stage SCI format: SCI format 2-A, SCI format 2-B, SCI
format 2-C
DMRS pattern
Beta offset indicator
DMRS port number
MCS
Additional MCS table indicator
Collision information receiver flag
Other information element(s)

The second-stage 2 SCI may include one or more information elements. The information elements included in the second-stage SCI may vary depending on a format of the second-stage SCI The second-stage SCI may include one or more information elements defined in Table 2 below.

TABLE 2
Information elements

HARQ process number
New data indicator (NDI)
Redundancy version (RV)
Source ID
Destination ID
HARQ feedback enable/disable indicator
Cast type indicator
Other information element(s)

A PSFCH may be configured periodically within an SL resource region. A slot in which a PSFCH is configured may be referred to as a PSFCH slot. The PSFCH slot may be configured according to a periodicity. The periodicity of the PSFCH slot may be referred to as a PSFCH transmission occasion resource (TPR). The PSFCH TPR may be defined on a slot basis within a resource pool. The PSFCH TPR may be 1 slot, 2 slots, or 4 slots. PRB(s) in which the PSFCH can be transmitted in the frequency domain may be indicated by a bitmap. The PRBs available for PSFCH transmission may be all PRBs or some PRBs. One PSFCH may be transmitted in one PRB. Alternatively, in an unlicensed band, one PSFCH may be transmitted in one or more PRBs.

The PRB(s) in which the PSFCH is transmitted may be determined based on a location of a slot in which a PSSCH associated with the PSFCH is received. A difference (e.g., slot offset, interval) between the slot in which the PSSCH is received and the slot in which the PSFCH is to be transmitted may be considered. For example, the PSFCH may be transmitted in a PSFCH slot occurring first after K slot(s) from a slot n in which the PSSCH is received. A PRB index (e.g., index of the PRB in which the PSFCH is transmitted) may be defined based on a function f(P_{PSFCH}, n, K, k_{subch}). The P_{PSFCH} may be a periodicity of the PSFCH. n may be the index of the slot in which the PSSCH is received. K may be a slot offset used to determine the PSFCH slot in which the PSFCH is transmitted. k_{subch} may be the index of the subchannel in which the PSCCH is configured.

In the function f(.) for determining the PRB index, at least one of a different code q, an identifier (ID) of the transmitting terminal, or an ID of the receiving terminal transmitting the PSFCH may be considered. The code q may be defined by a cyclic shift or a cyclic shift pair. The cyclic shifts may be related to different Zadoff-Chu sequences. The cyclic shift pair may refer to a pair of different sequences according to acknowledgment (ACK) or negative ACK (NACK).

A set of PRBs in which the PSFCH is transmitted may be determined based on a slot #n in which the PSSCH is transmitted and/or an index of a subchannel in which the PSSCH is transmitted. A code conveyed by the PSFCH and a PRB in the PRB set may be determined based on a function that considers at least one of the ID of the transmitting terminal or the ID of the receiving terminal transmitting the PSFCH.

The base station may transmit configuration information (e.g., transmission resource information) of SL channel(s) to the terminal. The terminal may receive the configuration information of SL channel(s) from the base station, and transmit SL channel(s) based on the configuration information (e.g., transmission resources indicated by the configuration information). Alternatively, the terminal may select resource(s) by performing a resource sensing operation and/or a resource selection operation, and may transmit SL channel(s) in the selected resource(s). The selected resource(s) may mean transmission resource(s). The transmission resource may include one or more subchannels and one or more slots.

The transmitting terminal may transmit an SCI including transmission resource information (e.g., scheduling information) of a PSSCH to the receiving terminal. The transmission resource information may be allocation information of subchannel(s) and/or slot(s) of the PSSCH. The transmitting terminal may refer to a terminal that transmits a PSSCH (e.g., data). The receiving terminal may refer to a terminal that receives the PSSCH (e.g., data). The transmission resource information included in the SCI may indicate a transmission resource of the PSSCH in a slot in which the SCI is transmitted. Alternatively, the transmission resource information included in the SCI may indicate a transmission resource of the PSSCH in a slot other than the slot in which the SCI is transmitted.

In SL-U communication, a listen-before-talk (LBT) operation may be performed for coexistence with other communication nodes (e.g., communication devices). Actual transmission resources may be determined based on a result of the LBT operation. The terminal may perform an LBT operation, and when the LBT operation succeeds, the terminal may use a channel for a specific time (e.g., channel occupancy time (COT)). For example, when the LBT operation of the terminal succeeds, a COT may be initiated by the terminal, and the terminal may perform communication (e.g., SL-U communication) during the COT. Depending on a specific condition, other terminals (e.g., terminals that have not initiated the COT) may perform communication (e.g., SL-U communication) during the COT. In other words, the COT may be shared with other terminal(s), and in this case, the other terminal(s) may perform communication within the shared COT.

A transmission unit (e.g., symbol configuration) within the COT may vary. Configuration information of a transmission unit within the COT may be transmitted through signaling (e.g., SCI). The symbol may refer to an OFDM symbol. In the exemplary embodiment of FIG. 8, a PSCCH and a PSSCH may be configured together within a transmission resource. The PSCCH may be configured starting from a PRB with the lowest index in a subchannel with the lowest index among subchannel(s) configured for PSSCH transmission.

Operations, procedures, control information, and/or configuration information for operating channel occupancy in SL-U communication will be described. An operating channel may refer to a frequency resource having a bandwidth of a predefined size. Resources (e.g., time resources, frequency resources, carriers, subcarriers, subchannels) of an unlicensed band may be occupied by a communication node belonging to a network (e.g., wireless local area network (WLAN)) other than a cellular network (e.g., 4G network, 5G network). Resources in an unlicensed band may be occupied by signals/channels transmitted and received between the base station and the terminal belonging to the cellular network. Resources in an unlicensed band may be occupied by signals/channels transmitted and received between terminals belonging to the cellular network.

In the present disclosure, a communication node (e.g., base station, terminal) transmitting a signal/channel may be expressed as a transmitting node, and a communication node (e.g., base station, terminal) receiving a signal/channel may be expressed as a receiving node. In an unlicensed band, communication nodes may share an operating channel. The LBT operation may be performed to minimize interference between communication nodes. The LBT operation may include an operation of identifying whether an operating channel is occupied by another signal before transmitting a signal/channel. When the LBT operation is supported, a communication node (e.g., transmitting node) may perform a random backoff procedure.

When the LBT operation succeeds, the communication node may occupy the operating channel. The occupancy of the operating channel may be referred to as channel occupancy (CO). The terminal may secure a CO by performing an LBT operation. Configuration of the CO may vary depending on a type of LBT operation performed by the terminal. For example, the maximum length of CO may vary depending on the type of LBT operation performed by the terminal. The type of LBT operation performed by the terminal may vary depending on a priority class of data to be transmitted by the terminal within the CO.

The terminal may perform the LBT operation using different parameters (e.g., different LBT parameters) to obtain a CO corresponding to each priority class. When the LBT operation is performed according to the priority class, the parameters that determine an execution time of the LBT operation may vary. In the LBT operation involving a random backoff procedure, the minimum and/or maximum size of a contention window (CW) may be set differently for each priority class. The terminal may select a random backoff counter within the CW and perform a random backoff procedure based on the selected random backoff counter.

A fixed time period in which the LBT operation is performed may be determined based on the type of LBT operation and/or LBT parameter(s). The length of the fixed time period may be 16 us or 25 μs. The communication node (e.g., transmitting node) that performed the LBT operation may transmit information on a CO (e.g., CO configuration information) obtained by the LBT operation to another communication node (e.g., receiving node). The CO configuration information may include LBT parameter(s) used for the LBT operation of the terminal. The LBT parameter(s) may include information of the priority class. The CO configuration information may include at least one of information of a start time of the CO, information of the length of the CO, or information of an end time of the CO. In the present disclosure, ‘time point’ may be interpreted as ‘time’.

The receiving node may receive the CO configuration information from the transmitting node, and identify the LBT parameter(s) used for obtaining the CO based on the CO configuration information. The receiving node may identify the priority class for the CO initiated by the transmitting node based on the LBT parameter(s). The receiving node may identify the CO initiated by the transmitting node based on the CO configuration information, and perform communication within the CO. For example, the receiving node may transmit and receive signals/channels within the CO.

The transmitting node may configure a channel occupancy time (COT). The configuration of the COT mean initiation of the COT. The COT may be configured within a time resource and/or a frequency resource. Configuration information of the COT (i.e., COT configuration information) may indicate a time resource and/or a frequency resource in which the COT is configured. The COT may be referred to as a CO or channel occupancy resource (COR) In an unlicensed band, resources may be shared by multiple communication nodes. A communication node may use non-consecutive resources (e.g., non-consecutive time resources and/or non-consecutive frequency resources). In this case, signal/channel transmission in an unlicensed band may be performed in a discontinuous burst scheme. The burst scheme may refer to transmission performed in a transmission resource including one or more slots.

A signal/channel may be transmitted in a time with a length shorter than a slot. The time with a length shorter than a slot may include consecutive symbols. The time with a length shorter than a slot may be a mini-slot. Consecutive transmission resources may be configured within a COT. The transmitting node may transmit an initial signal and/or a burst signal (e.g., PSSCH, PSFCH, PSCCH, reference signal) within the COT. The initial signal may be a signal obtained by duplicating a signal of the first symbol in which SL transmission is performed. Alternatively, the initial signal may be a signal composed of a cyclic prefix (CP).

In SL-U communication, the terminal may perform an LBT operation before transmitting a signal/channel. If a result of the LBT operation indicates an idle state, the terminal may transmit a signal/channel. If the result of the LBT operation indicates a busy state, the terminal may not transmit a signal/channel. “The result of the LBT operation indicates the idle state” may mean “the LBT operation succeeds”. “The result of the LBT operation indicates the busy state” may mean “the LBT operation fails”. Based on a result of comparison between an energy detection level and a predefined threshold, the result of the LBT operation may be determined as indicating the idle state or busy state.

The LBT operation may be classified into a type 1 LBT operation and a type 2 LBT operation. In the type 1 LBT operation, a channel sensing time may be variable. In other words, the type 1 LBT operation may be performed in a variable time period. The channel sensing time may be changed by a random variable. The type 1 LBT operation may refer to an LBT operation involving a random backoff procedure. In the type 2 LBT operation, a channel sensing time may be fixed. In other words, the type 2 LBT operation may be performed in fixed time period. The channel sensing time may be m μs. m may be a natural number.

When the type 1 LBT operation is performed, the terminal may randomly select a value N according to a uniform probability within the CW. The value N may be an integer. The value N may be a random backoff counter. The terminal may perform a channel sensing operation in a predefined sensing period (e.g., sensing slot period). The channel sensing operation may mean an energy detection operation for time and/or frequency resource(s). If a result of the channel sensing operation in one sensing period indicates an idle state, the terminal may decrease the value N selected within the CW by 1. If the result of the channel sensing operation in one sensing period indicates a busy state, the terminal may additionally perform the channel sensing operation. If the result of the channel sensing operation in N sensing periods indicates an idle state, the terminal may transmit a signal/channel.

The terminal may perform a channel access procedure to use the unlicensed band. The channel access procedure may be an LBT operation. The terminal may initiate a COT by performing the channel access procedure. In other words, if the terminal's channel access procedure is successful, the terminal may initiate a COT. In the present disclosure, ‘a terminal has started (e.g., initiated) a COT’ may mean that the terminal has obtained the COT and/or that the terminal has configured the COT. The terminal may perform an LBT operation (e.g., type 1 LBT operation) to initiate the COT. The terminal may initiate the COT when the type 1 LBT operation is successful. The terminal may initiate the COT by performing a semi-static channel access procedure.

An LBT operation (e.g., type of LBT operation) performed by the terminal for transmission of a signal/channel within a COT may be different from an LBT operation (e.g., type of LBT operation) performed by the terminal for transmission of a signal/channel outside a COT. The terminal may perform a type 2 LBT operation for signal/channel transmission within a COT. The type 2 LBT operation may be performed in a fixed time period. The terminal may perform a type 1 LBT operation for signal/channel transmission outside of a COT. The type 1 LBT operation may be performed in a variable time period.

The terminal may share the initiated COT with other terminals. This operation may be referred to as ‘COT sharing operation’. In the present disclosure, a terminal that shares an initiated COT (e.g., obtained COT) with another terminal may be referred to as ‘terminal A’, while terminal that utilizes a COT (e.g., obtained COT) initiated by another terminal may be referred to as ‘terminal B’. In addition, the terminal A may be referred to as a first terminal or a second terminal, and the terminal B may be referred to as a second terminal or a first terminal.

The terminal A may perform an LBT operation using different LBT parameters depending on a priority class of data. Depending on the priority class, LBT parameters (e.g., contention window, length of a sensing period (e.g., sensing window), etc.) used for the LBT operation may vary. The priority class may be selected by the terminal A. The maximum length of COT may vary depending on a result of the LBT operation according to the priority class. The priority class may mean a channel access priority class (CAPC).

The terminal A may initiate a COT according to the result of the LBT operation. If the LBT operation is successful, the terminal A may initiate a COT. If the LBT operation fails, the terminal A may not be able to initiate a COT. The terminal A may transmit a signal/channel within the COT. The terminal A's transmission within the COT may be SL transmission or uplink (UL) transmission. The terminal A may transmit information on the initiated COT (e.g., COT configuration information, COT sharing information) to the terminal B. The COT configuration information and COT sharing information may be the same information. The COT configuration information may be CO configuration information, and the COT sharing information may be CO sharing information. The terminal B may receive information on the COT initiated by the terminal A from the terminal A, and may transmit a signal/channel within the COT initiated by the terminal A.

Methods of configuring signals in a communication network (e.g., sidelink communication) will be described. Methods of configuring signals may refer to methods of configuring channels. In the present disclosure, ‘signal’ may have a meaning encompassing a signal and/or channel. In addition, ‘channel’ may have a meaning encompassing a signal and/or channel. The terminal may generate (e.g., configure) an OFDM signal. The terminal may copy a signal portion from an ending part of the OFDM symbol in the time domain, and arrange the copied signal portion before the OFDM symbol. The copied signal portion arranged before the OFDM symbol may be a cyclic prefix (CP). The OFDM signal may be simply referred to as a signal. The OFDM symbol may be referred to simply as a symbol.

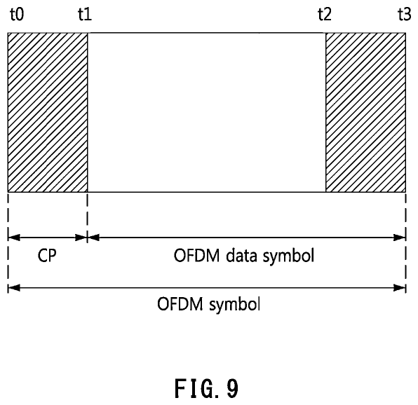

FIG. 9 is a conceptual diagram illustrating exemplary embodiments of a method of configuring signals in a communication network.

Referring to FIG. 9, a terminal may configure an OFDM data symbol. The length of one OFDM data symbol may correspond to a period from time t1 to time t3. The terminal may copy a signal from an ending part of the OFDM data symbol (e.g., period from time t2 to time t3) and arrange the copied signal before the OFDM data symbol. The copied signal may be arrange in a period from time to to time t1. The copied signal arrange in the period from time t0 to time t1 may be a cyclic prefix (CP). A signal configuration of the CP may be the same as a signal configuration in the period from time t2 to time t3. A sum of the CP and the OFDM data symbol may be an OFDM symbol.

The length of CP may be a fixed value depending on a configuration by the communication network. The length of the OFDM symbol may be a fixed value depending on a configuration by the communication network. The terminal may configure an additional CP in addition to the CP. The additional CP may be referred to as ‘extended CP’. The extended CP may mean a cyclic prefix extension (CPE). The extended CP may be located in front of the OFDM symbol (e.g., before the CP of the OFDM symbol) in the time domain. The extended CP may be configured based on a period before the period used for the CP within the OFDM data symbol (e.g., period before time t2 in FIG. 9).

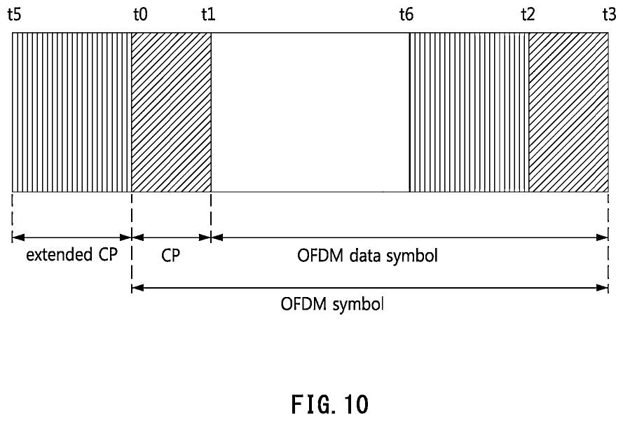

FIG. 10 is another conceptual diagram illustrating exemplary embodiments of a method of configuring signals in a communication network.

Referring to FIG. 10, a terminal may configure an OFDM data symbol. The length of one OFDM data symbol may correspond to a period from time t1 to time t3. The terminal may copy a signal in a period from time t2 to time t3 within the OFDM data symbol, and arrange the copied signal before the OFDM data symbol. The copied signal may be arrange in a period from time t0 to time t1. The copied signal arranged in the period from time t0 to time t1 may be a CP. A signal configuration of the CP may be the same as a signal configuration in the period from time t2 to time t3. A sum of the CP and the OFDM data symbol may be an OFDM symbol.

The terminal may copy a signal in a period from time t6 to time t2 within the OFDM data symbol, and arrange the copied signal in front of the OFDM symbol (e.g., before the CP of the OFDM symbol). The copied signal may be arranged in a period from time t5 to time t0. The copied signal arranged in the period from time t5 to time t0 may be an extended CP. A signal configuration of the extended CP may be the same as a signal configuration in the period from time t6 to time t2. A sum of the extended CP and the CP may be interpreted as a CPE.

The extended CP may be located before a specific OFDM symbol. The specific OFDM symbol may be an automatic gain control (AGC) symbol. The AGC symbol may be a symbol used for AGC purposes. The extended CP may be configured (e.g., arranged) in front of the AGC symbol. In the exemplary embodiment of FIG. 10, the OFDM symbol configured in the period from time t0 to time t3 may be an AGC symbol.

The terminal may configure an extended CP as needed. The length of the extended CP in the time domain may be set variably. In the time domain, a start time of an extended CP may be set variably. The start time may mean a start time point, a start position, etc. If the length of the extended CP in the time domain (e.g., information indicating the length of the extended CP) is set (e.g., indicated) to the terminal, the terminal may configure the extended CP corresponding to the length at a start time (e.g., first symbol) of a transmission signal. The transmission signal may be a signal that the terminal wishes to transmit. For example, if the transmission signal of the terminal is configured from time to and the length of the extended CP is y, the terminal may configure the extended CP in a period from time (t0−y) to time to.

If the length of the extended CP in the time domain is set (e.g., indicated) to the terminal, the terminal may configure the extended CP in a period from the start time of the extended CP to the start time of the terminal's transmission signal. For example, if the transmission signal of the terminal is configured from time to and the start time of the extended CP is x, the terminal may configure the extended CP in a period from time x to time to. The extended CP may be a CPE. Configuration information of the extended CP (e.g., extended CP configuration information or CPE configuration information) may include at least one of information indicating the length of the extended CP or information indicating the start time (e.g., start position) of the extended CP. The extended CP configuration information may include information indicating one or more start times (e.g., one or more start position(s)) of the extended CP (e.g., CPE). The one or more start positions of the extended CP may be candidate start position(s).

The base station may transmit the CPE configuration information including information on the one or more start positions of the CPE to the terminal. The terminal may receive the CPE configuration information from the base station and identify information on the one or more start positions of the CPE included in the CPE configuration information. The one or more start positions of the CPE may be referred to as CPE start position(s). The CPE configuration information may be included in SL-BWP-Config and/or SL-ResourcePool. The CPE start position(s) may be configured per channel and/or signal. For example, CPE start position(s) for S-SSB may be configured to the terminal. In the case, the CPE start position(s) may be located within a guard period (GP) symbol before S-SSB transmission. CPE start position(s) for PSFCH may be configured to the terminal. In this case, the CPE start position(s) may be located within a GP symbol before PSFCH transmission.

CPE start position(s) for PSCCH may be configured to the terminal. A PSCCH may be a PSCCH transmitted for COT initiation or a PSCCH transmitted within a COT. The CPE start position(s) for PSCCH may include a default CPE start position and/or candidate CPE start position(s). CPE start position(s) for PSSCH may be configured to the terminal. A PSSCH may be a PSSCH transmitted for COT initiation or a PSSCH transmitted within a COT. The CPE start position(s) for PSSCH may include a default CPE start position and/or candidate CPE start position(s). The default CPE start position may be used when candidate CPE start position(s) are not configured to the terminal. In other words, if candidate CPE start position(s) are configured to the terminal, the default CPE start position may not be used.

The CPE configuration information may vary depending on the communication network. For example, the CPE configuration information (e.g., CPE length and/or CPE start position(s)) may vary depending on a subcarrier spacing (SCS) of the communication network. If the SCS is 15 kHz in the communication network, the CPE length may be up to the length of one OFDM symbol. If the SCS is 30 kHz or higher in the communication network, the CPE length may be up to the length of two OFDM symbols. The length of the OFDM symbol may vary depending on the SCS. The length of one OFDM symbol in 15 kHz SCS may be the same or similar to the length of two OFDM symbols in 30 kHz SCS. The CPE start time (e.g., CPE start position) may be set to be at least X μs later from a start time of a symbol where the CPE is located. X may be a natural number. For example, X may be 16.

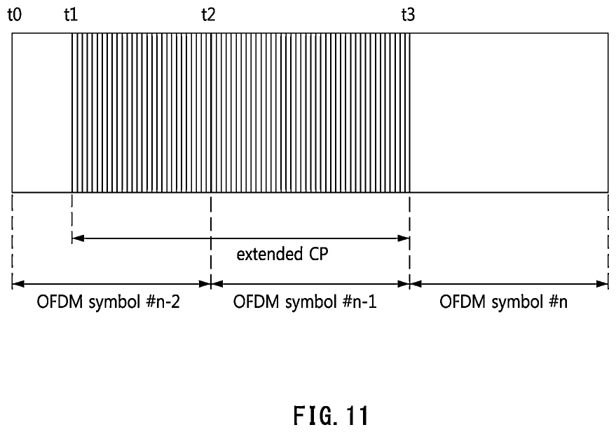

FIG. 11 is yet another conceptual diagram illustrating exemplary embodiments of a method of configuring signals in a communication network.

Referring to FIG. 11, an extended CP (e.g., CPE) may be configured before an OFDM symbol #n. The OFDM symbol #n may be an AGC symbol. The extended CP may be configured within OFDM symbols #n-2 and #n-1. The extended CP may be configured in a period from time t1 to time t3. The time t3 may be a start time of the OFDM symbol #n. The time t1 may be a start time (e.g., start position) of the extended CP. The time t1 (e.g., the start time of the extended CP) may be at least X μs from the start time (e.g., t0) of the OFDM symbol #n-2. X may be a natural number. For example, X may be 16. The time t1 may not be located within X μs from the time to. The start time (e.g., time t1) of the extended CP may be a discrete time point. The start time of the extended CP may discretely exist with intervals corresponding to an LBT sensing period. The length of the LBT sensing period may be Y μs. Y may be a natural number. For example, Y may be 9. Start times (e.g., candidate start times) of the extended CP may be set at intervals of Y μs after X μs from the time to. For example, the start times (e.g., candidate start times) of the extended CP may be (t0+X) μs, (t0+X+Y) μs, (t0+X+2Y) μs, and the like.

The start times (e.g., candidate start times, candidate start positions) of the extended CP may vary depending on a configuration by the communication network. For example, the start times of the extended CP for the OFDM symbol #n that the terminal wishes to transmit may exist from the OFDM symbol #n-2. In this case, the start times (e.g., candidate start times) of the extended CP may be (t0+X) μs, (t0+X+Y) μs, (t0+X+2Y) μs, etc. In other words, a list of the extended CP start times (e.g., candidate start times) may include (t0+X) μs, (t0+X+Y) μs, (t0+X+2Y) μs, etc. For another example, the extended CP start times for the OFDM symbol #n that the terminal wishes to transmit may exist starting from the OFDM symbol #n-1. In this case, the extended CP start times (e.g., candidate start times) may be (t2+X) μs, (t2+X+Y) μs, (t2+X+2Y) μs, etc. In other words, a list of the extended CP start times (e.g., candidate start times) may include (t2+X) μs, (t2+X+Y) μs, (t2+X+2Y) μs, etc.

The base station may transmit the list of the extended CP start times (e.g., candidate start times) to the terminal through signaling. The terminal may obtain the list of the extended CP start times (e.g., candidate start times) from the base station. If the terminal does not configure the extended CP, the time t1 and time t3 may be the same time.

In the communication network, the terminal may configure an extended CP differently depending on a priority of data (e.g., PSCCH and/or PSSCH) that the terminal wishes to transmit. In other words, an extended CP may be configured differently depending on the priority of data. The priority may be a layer 1 (L1)-priority. If the priority is an L1-priority, the priority (e.g., L1-priority) may be classified into eight levels. Alternatively, the priority may be a channel access priority class (CAPC). When the priority is a CAPC, the priority (e.g., CAPC) may be classified into four levels. The data may refer to user data and/or control data.

The L1-priority may be related to the priority of data that the terminal wishes to transmit. Information on the priority may be indicated (e.g., configured) by higher layer signaling. L1-priority information may be the same as priority information transmitted through first-stage SCI. An extended CP start time (e.g., start position) that can be configured by the terminal may vary depending on a configuration by the communication network. The configuration by the communication network may be an SCS and/or the number of OFDM symbols for which configuration of the extended CP is allowed. The SCS may be either 15 kHz, 30 kHz, 60 kHz, or 120 kHz. The number of OFDM symbols for which configuration of the extended CP is allowed may be 1 or 2.

A set (e.g., list) including extended CP start times (e.g., all start times), which can be configured by the terminal for the configuration by the communication network, may be defined as a base set (e.g., base list). The extended CP start times, which can be configured by the terminal, may mean candidate CPE start positions. Elements of the base set may indicate different start times of the extended CP.

The terminal may configure a per-priority subset according to the priority of the data to be transmitted. Elements of each subset may include one or more elements from the base set. For example, the base set of extended CP start times may include N elements. A subset including K elements for each of M priorities may be configured. N, M, and K may each be a natural number. The element(s) of the base set may be mapped to a subset (e.g., elements of the subset). In other words, one element of the base set may be configured to be mapped to one subset. That is, the mapping relationship between the elements of the base set and the subset may be a one-to-one mapping relationship.

The mapping between the priority and the element(s) of the subset corresponding to the priority may be preconfigured in the communication network (e.g., base station and/or terminal). The mapping between the priority and the element(s) of the subset corresponding to the priority may vary depending on a configuration by the communication network. Mapping of the priority of data to be transmitted by the terminal and elements of the subset corresponding to the priority may be performed by considering the priority and the start time of the extended CP. For example, an element corresponding to an earlier start time of the extended CP in the time domain may be mapped to a subset with a higher priority. An element corresponding to an earlier start time of an extended CP in the time domain may mean an extended CP with a longer length. For example, an element corresponding to a later start time of an extended CP in the terminal may be mapped to a subset with a lower priority. An element corresponding to a later start time of an extended CP in the time domain may mean an extended CP with a shorter length.

If two or more elements exist in a subset corresponding to a priority, the terminal may randomly select one element from the two or more elements, and configure an extended CP based on the selected element. If a priority of data that the terminal wishes to transmit is L, and there are K elements in a subset corresponding to the priority L, the terminal may randomly select one element among the K elements, and may configure an extended CP based on the selected one element. Each of L and K may be a natural number. The random selection operation may mean an operation of selecting one element with uniform probability for elements belonging to the subset.

Depending on a configuration by the communication network, a default value for an extended CP start time may be set. The default value for the extended CP start time may mean a default CPE start time. A default extended CP start time may mean a default CPE start position. The default extended CP start time may be set to one value regardless of priorities. The default extended CP start time may be set independently for each priority. The default extended CP start time may be set differently for each priority. The default extended CP start time may be set as an element corresponding to the earliest extended CP start time in the time domain among the elements of the base set. Alternatively, the default extended CP start time may be set as an element corresponding to the latest extended CP start time in the time domain among the elements of the base set. Alternatively, the default extended CP start time may be set as an element corresponding to the earliest extended CP start time in the time domain among the elements of the per-priority subset. Alternatively, the default extended CP start time may be set as an element corresponding to the latest extended CP start time in the time domain among the elements of the per-priority subset.

The terminal may configure an extended CP using the default extended CP start time (e.g., default CPE start position) according to a condition. When resource reservation information (e.g., resource allocation information) for a resource region (e.g., time and/or frequency region) in which the terminal wishes to transmit data is received, the terminal may use the default extended CP start time to configure an extended CP. The resource reservation information may be information received through SCI (e.g., first-stage SCI and/or second-stage SCI). Alternatively, the resource reservation information may be information received from the base station through DCI.

A terminal (e.g., transmitting terminal) may transmit resource reservation information (e.g., resource allocation information) for a resource region (e.g., time and/or frequency region) in which the terminal wishes to transmit data. In this case, the terminal (e.g., transmitting terminal) may configure an extended CP using the default extended CP start time, and transmit a signal and/or channel including the extended CP. The resource reservation information may be information for reserving a resource for the terminal to transmit the data. The resource reservation information may be information transmitted by the terminal. The resource reservation information may be information transmitted through SCI (e.g., first-stage SCI and/or second-stage SCI).

If the above-mentioned condition (e.g., reception and/or transmission of the resource reservation information) is met, the terminal may configure the extended CP using the default extended CP start time, and transmit a signal and/or channel including the extended CP.

Depending on whether a resource region (e.g., time and/or frequency region) of data that the terminal wishes to transmit is included within a COT, a subset of extended CP start times may be configured differently. A subset of extended CP start times for a case where the resource region of the data (e.g., PSCCH and/or PSSCH) exists within a COT and a subset of extended CP start times for a case where the resource region of the data does not exist within a COT may be configured individually. In other words, the subset of extended CP start times for a case where the resource region of the data exists within a COT and the subset of extended CP start times for a case where the resource region of the data does not exist within a COT may be configured independently. The case where the resource region of the data exists within a COT may correspond to a case that the COT is shared with the terminal. The case where the resource region of the data does not exist within a COT may correspond to a case that the terminal initiates the COT.

For a terminal initiating a COT, the base station may configure a default CPE start position and/or a list of CPE start position(s) (e.g., candidate CPE start position(s)) for PSCCH/PSSCH transmission to the terminal. The PSCCH/PSSCH transmission may refer to PSCCH transmission and/or PSSCH transmission. The list may be a set of index(es) corresponding to CPE start position(s) (e.g., candidate CPE start position(s)). The list may include an L1-priority, and the CPE start position(s) (e.g., candidate CPE start position(s)) belonging to the list may be associated with the L1-priority of a PSSCH. When the terminal initiates a COT, the terminal may perform PSCCH transmission and/or PSSCH transmission based on the default CPE start position configured by the base station. Alternatively, when the terminal initiates a COT, the terminal may select at least one CPE start position (e.g., candidate CPE start position) among the CPE start position(s) (e.g., candidate CPE start position(s)) belonging to the list configured by the base station, and may perform the PSCCH transmission and/or PSSCH transmission based on the at least one CPE start position (e.g., candidate CPE start position).

The base station may configure a default CPE start position and/or a list of CPE start position(s) (e.g., candidate CPE start position(s)) for the terminal's PSCCH/PSSCH transmission within a COT to the terminal. The list may be a set of index(es) corresponding to CPE start position(s) (e.g., candidate CPE start position(s)). The list may include an L1-priority, and the CPE start position(s) (e.g., candidate CPE start position(s)) belonging to the list may be associated with the L1-priority of a PSSCH. The terminal may perform PSCCH transmission and/or PSSCH transmission based on the default CPE start position configured by the base station within the COT. Alternatively, the terminal may select at least one CPE start position (e.g., candidate CPE start position) among the CPE start position(s) (e.g., candidate CPE start position(s)) belonging to the list configured by the base station, and may perform the PSCCH transmission and/or PSSCH transmission based on the at least one CPE start position (e.g., candidate CPE start position) within the COT.

If the terminal initiates a COT and the terminal receives resource reservation information for a resource region (e.g., time and/or frequency region) for data transmission, the terminal may configure an extended CP using the default extended CP start time (e.g., default CPE start position). The resource reservation information may be information received from another terminal (or base station). The resource reservation information may be information received through SCI (e.g., first-stage SCI and/or second-stage SCI) or DCI.

If the terminal initiates a COT and the terminal transmits resource reservation information for a resource region (e.g., time and/or frequency region) for data transmission, the terminal may configure an extended CP using the default extended CP start time (e.g., default CPE start position). The resource reservation information may be information on resource reservation for data transmission of the terminal (e.g., PSCCH transmission and/or PSSCH transmission). The resource reservation information may be information transmitted by the terminal. The resource reservation information may be information transmitted through SCI (e.g., first-stage SCI and/or second-stage SCI).

If the terminal initiates a COT and the above-mentioned condition (e.g., reception and/or transmission of resource reservation information) is met, the terminal may configure an extended CP using the default extended CP start time, and perform transmission (e.g., SL transmission) based on the extended CP. If the terminal initiates a COT and the above-mentioned condition (e.g., reception and/or transmission of resource reservation information) is not met, the terminal may randomly select one of elements in the subset (e.g., list), configure an extended CP using the one selected element, and perform transmission (e.g., SL transmission) based on the extended CP.

The number of elements belonging to the subset for extended CP start times for a case when a COT is shared with the terminal may be set to be smaller than the number of elements belonging to the subset for extended CP start times for a case when a transmission resource region of the terminal does not exist within a COT. The elements belonging to the subset for extended CP start times for the case when a COT is shared with the terminal may be elements corresponding to earlier extended CP start times in the time domain among the elements belonging to the subset of extended CP start times for the case when a transmission resource region of the terminal does not exist within a COT.

If a COT is shared with the terminal, a subset for extended CP start times may include one element. The one element may be the default extended CP start time. In other words, if a COT is shared with the terminal, a start time of an extended CP may be determined (e.g., set) as the default extended CP start time. Alternatively, if a COT is shared with the terminal, a subset for extended CP start times may include one or more elements. The one or more elements may include the default extended CP start time. If the subset of extended CP start times includes one or more elements, the terminal may configure an extended CP using the default extended CP start time. Alternatively, if the subset of extended CP start times includes one or more elements, the terminal may randomly select one element among the one or more elements, and configure an extended CP using the selected element.

If a COT is shared with the terminal and the terminal receives resource reservation information for a transmission resource region (e.g., time and/or frequency region) of data transmission, the terminal may configure an extended CP using the default extended CP start time. The resource reservation information may be information received from another terminal (or base station). The resource reservation information may be information received through SCI (e.g., first-stage SCI and/or second-stage SCI) or DCI.

If a COT is shared with the terminal and the terminal transmits resource reservation information for a transmission resource region (e.g., time and/or frequency region) of data, the terminal may configure an extended CP using the default extended CP start time. The resource reservation information may be information transmitted by the terminal. The resource reservation information may be information transmitted through SCI (e.g., first-stage SCI and/or second-stage SCI).

If a COT is shared with the terminal and the above-mentioned condition (e.g., reception and/or transmission of resource reservation information) is met, the terminal may configure an extended CP using the default extended CP start time, and perform transmission (e.g., PSCCH transmission and/or PSSCH transmission) based on the extended CP. If a COT is shared with the terminal and the above-mentioned condition (e.g., reception and/or transmission of resource reservation information) is not met, the terminal may randomly select one element among elements belonging to the subset, configure an extended CP using the one selected element, and perform transmission (e.g., PSCCH transmission and/or PSSCH transmission) based on the extended CP.

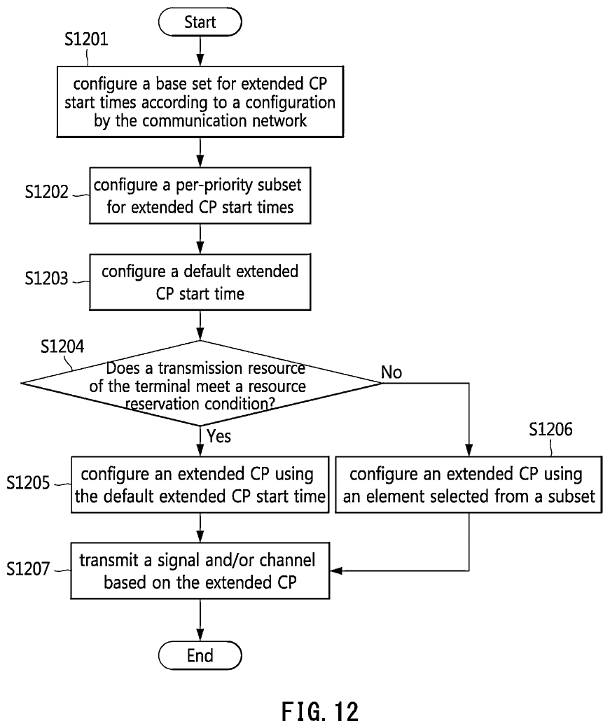

FIG. 12 is a flowchart illustrating exemplary embodiments of a method for configuring an extended CP in a communication network.

Referring to FIG. 12, a base station may transmit communication network configuration information to terminal(s). A terminal may receive the communication network configuration information from the base station. The terminal may configure a base set for extended CP start times based on a configuration of the communication network (S1201). The terminal may configure a subset of extended CP start times for each priority by using elements in the base set (S1202). The terminal may set a default extended CP start time for each per-priority subset (S1203). The terminal may determine whether a transmission resource (e.g., transmission resource region) of the terminal meets a resource reservation condition (S1204). If the transmission resource of the terminal meets the resource reservation condition, the terminal may configure an extended CP using the default extended CP start time (S1205). If the transmission resource of the terminal does not meet the resource reservation condition, the terminal may select one element from among elements belonging to the subset, and configure an extended CP using the selected element (S1206). The terminal may transmit a signal and/or channel based on the extended CP (S1207). In other words, the terminal may perform SL transmission based on the extended CP. The signal and/or channel may include at least one of S-SSB, PSCCH, PSSCH, or PSFCH.

In the procedure for selecting one element, the terminal may randomly select one element from among the elements belonging to the subset. The resource reservation condition may be a case when another terminal's resource reservation information for a transmission resource is received and/or a case when the terminal transmits resource reservation information for a transmission resource.

If a COT is shared with the terminal, the terminal may receive COT sharing information including extended CP start time-related information, and identify the extended CP start time-related information included in the COT sharing information. The COT sharing information may be received from the base station or another terminal. The extended CP start time-related information included in the COT sharing information may include information on a base set of extended CP start times. The extended CP start time-related information included in the COT sharing information may include information on a subset of extended CP start times. The extended CP start time-related information included in the COT sharing information may include extended CP start time(s). The terminal may configure an extended CP based on the extended CP start time-related information included in the COT sharing information. The terminal may configure an extended CP based on the extended CP start time-related information within the shared COT.

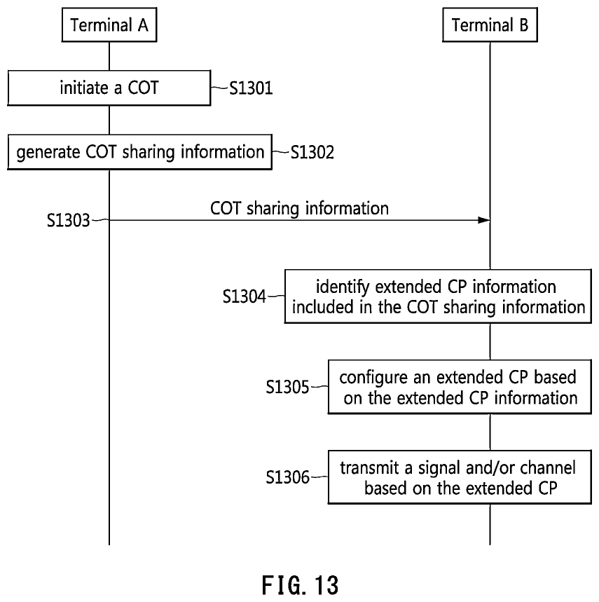

FIG. 13 is a sequence chart illustrating exemplary embodiments of a method for configuring an extended CP in a communication network.

Referring to FIG. 13, a terminal A may initiate a COT (S1301). In other words, the terminal A may obtain the COT. The terminal may generate COT sharing information to indicate COT sharing (S1302). The COT sharing information may include extended CP information (e.g., extended CP start time-related information). The extended CP information may include at least one of information of a base set for extended CP start times (e.g., information on element(s) belonging to the base set), information of a subset for extended CP start times (e.g., information on element(s) belonging to the subset), information on a default extended CP start time, or information on an extended CP start time.

The terminal A may transmit the COT sharing information to a terminal B to indicate COT sharing to the terminal B (S1303). The terminal B may receive the COT sharing information from the terminal A, and may identify that the COT initiated by terminal A is shared with the terminal B based on the COT sharing information. The terminal B may identify the extended CP information included in the COT sharing information (S1304). The terminal B may configure an extended CP using the extended CP information (S1305). The terminal B may transmit a signal and/or channel to another terminal based on the extended CP (S1306). The signal and/or channel may include at least one of S-SSB, PSCCH, PSSCH, or PSFCH.

The terminal may configure the extended CP differently depending on a type of signal and/or channel it wishes to transmit. For PSFCH transmission, the subset for extended CP start times may include one element. In other words, a start time of the extended CP for PSFCH transmission may be fixed. The subset of extended CP start times for PSFCH transmission may be configured for each resource pool. Alternatively, the subset of extended CP start times for PSFCH transmission may be configured for each BWP.

For S-SSB transmission, the subset for extended CP start times may include one element. In other words, a start time of the extended CP for S-SSB transmission may be fixed. The subset of extended CP start times S-SSB transmission may be configured for each resource pool. Alternatively, the subset of extended CP start times for S-SSB transmission may be configured for each BWP.

For PSCCH transmission and/or PSSCH transmission, the subset of extended CP start times may be configured differently depending on whether a COT is shared and/or depending on a resource reservation condition (e.g., whether the resource reservation condition is met). The subset of extended CP start times for PSCCH transmission and/or PSSCH transmission may be configured for each resource pool. Alternatively, the subset of extended CP start times for PSCCH transmission and/or PSSCH transmission may be configured for each BWP.

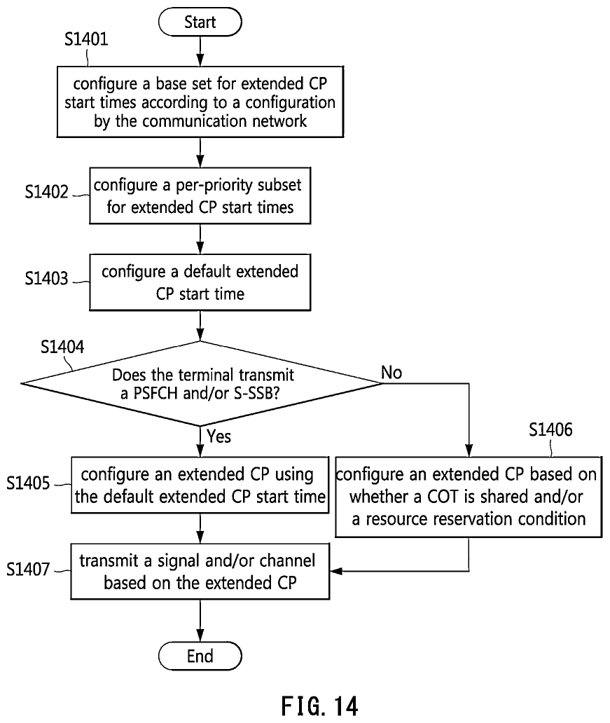

FIG. 14 is another flowchart illustrating exemplary embodiments of a method for configuring an extended CP in a communication network.

Referring to FIG. 14, a base station may transmit communication network configuration information to terminal(s). A terminal may receive the communication network configuration information from the base station. The terminal may configure a base set for extended CP start times based on a configuration of the communication network (S1401). The terminal may configure a subset of extended CP start times for each priority by using elements in the base set (S1402). The terminal may set a default extended CP start time for each per-priority subset (S1403). The terminal may determine whether to perform PSFCH transmission and/or S-SSB transmission (S1404).

If the terminal wishes to perform PSFCH transmission and/or S-SSB transmission, the terminal may configure an extended CP using the default extended CP start time (S1405). If the terminal wishes to perform transmission other than PSFCH transmission and/or S-SSB transmission (e.g., PSCCH transmission and/or PSSCH transmission), the terminal may configure an extended CP depending on whether a COT is shared and/or depending on a resource reservation condition (e.g., whether or not the resource reservation condition is met) (S1406). Whether or not a COT is shared may mean whether a COT initiated by another terminal (or base station) is shared with the terminal. The resource reservation condition may refer to a case when the terminal receives resource reservation information for a transmission resource region from another terminal and/or a case when the terminal transmits resource reservation information for a transmission resource region. The terminal may transmit a signal and/or channel based on the extended CP (S1407). In other words, the terminal may perform SL transmission based on the extended CP. The signal and/or channel may include at least one of S-SSB, PSCCH, PSSCH, or PSFCH.

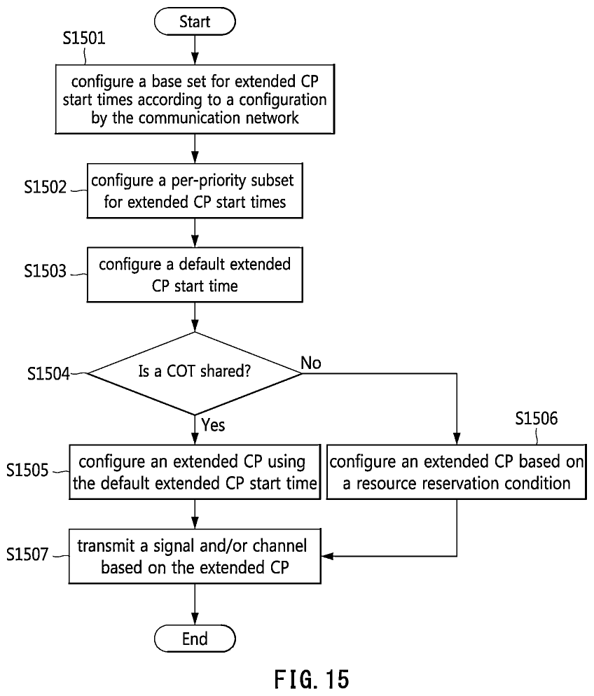

FIG. 15 is yet another flowchart illustrating exemplary embodiments of a method for configuring an extended CP in a communication network.

Referring to FIG. 15, a base station may transmit communication network configuration information to terminal(s). A terminal may receive the communication network configuration information from the base station. The terminal may configure a base set for extended CP start times based on a configuration of the communication network (S1501). The terminal may configure a subset of extended CP start times for each priority by using elements in the base set (S1502). The terminal may set a default n extended CP start time for each per-priority subset (S1503). The terminal may check whether a COT initiated by another terminal (or base station) is shared (S1504).

If a COT initiated by another terminal (or base station) is shared with the terminal, the terminal may configure an extended CP using the default extended CP start time (S1505). If a COT initiated by another terminal (or base station) is not shared with the terminal (e.g., if the terminal initiates a COT), the terminal may configure an extended CP according to a resource reservation condition (S1506). The resource reservation condition may refer to a case when the terminal receives resource reservation information for a transmission resource region from another terminal and/or a case when the terminal transmits resource reservation information for a transmission resource region. The terminal may transmit a signal and/or channel based on the extended CP (S1507). In other words, the terminal may perform SL transmission based on the extended CP. The signal and/or channel may include at least one of S-SSB, PSCCH, PSSCH, or PSFCH.

Meanwhile, the terminal may transmit consecutive signals in the time domain. There may be a time interval between the consecutive signals, and an extended CP may be configured to reduce the time interval. The configuration of the extended CP may vary depending on a type of signal (e.g., signal and/or channel) transmitted by the terminal. The terminal may perform a first signal transmission, and may perform a second signal transmission after the first signal transmission. The first signal transmission may include transmission of at least one of PSFCH, S-SSB, PSCCH, or PSSCH. The second signal transmission may include transmission of at least one of PSFCH, S-SSB, PSCCH, or PSSCH.

A time interval may exist between the first signal transmission and the second signal transmission. The time interval may be a gap (e.g., transmission gap). The length of the time interval may vary depending on a configuration by the communication network. For example, the length of the time interval between the first signal transmission and the second signal transmission may be a length corresponding to one OFDM symbol or two OFDM symbols. The maximum length of the time interval may vary depending on a configuration by the communication network. For example, the maximum length of the time interval between the first signal transmission and the second signal transmission may be a length corresponding to one OFDM symbol or two OFDM symbols.

The terminal may configure an extended CP according to a type of signal transmitted through the second signal transmission. When the second signal transmission is PSFCH transmission and/or S-SSB transmission, the terminal may configure the extended CP based on an extended CP configuration method 1. When the second signal transmission is PSCCH transmission and/or PSSCH transmission, the terminal may configure the extended CP based on an extended CP configuration method 2.

In the extended CP configuration method 1, the extended CP may be configured according to a configuration by the communication network. The configuration by the communication network may be indicated by a higher layer message (e.g., RRC configuration). The base station may generate RRC configuration information including extended CP configuration information for PSFCH transmission (e.g., extended CP start time-related information) and transmit the RRC configuration information to the terminal. The terminal may receive the RRC configuration information from the base station, identify the extended CP configuration information for PSFCH transmission included in the RRC configuration information, configure an extended CP based on the extended CP configuration information, and perform PSFCH transmission based on the extended CP. In other words, when the second signal transmission is PSFCH transmission, the terminal may configure the extended CP based on the extended CP configuration information for PSFCH transmission indicated by the RRC configuration information.

The base station may generate RRC configuration information including extended CP configuration information for S-SSB transmission (e.g., extended CP start time-related information) and transmit the RRC configuration information to the terminal. The terminal may receive the RRC configuration information from the base station, identify the extended CP configuration information for S-SSB transmission included in the RRC configuration information, configure an extended CP based on the extended CP configuration information, and perform S-SSB transmission based on the extended CP. In other words, when the second signal transmission is S-SSB transmission, the terminal may configure the extended CP based on the extended CP configuration information for S-SSB transmission indicated by the RRC configuration information.

In the extended CP configuration method 2, the terminal may configure an extended CP based on a predefined method. The extended CP may be predefined according to the time interval between the first signal transmission and the second signal transmission. The extended CP may be predefined according to an SCS of the communication network. When the second signal transmission is PSCCH transmission and/or PSSCH transmission, the terminal may configure the extended CP based on the predefined method (e.g., preconfigured method). In other words, the terminal may determine a start time of the extended CP based on the predefined method, configure the extended CP based on the start time of the extended CP, and perform PSCCH transmission and/or PSSCH transmission based on the extended CP.

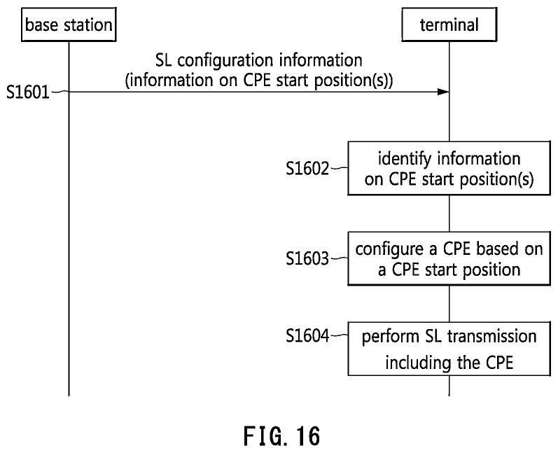

FIG. 16 is another sequence chart illustrating exemplary embodiments of a method for configuring an extended CP in a communication network.

Referring to FIG. 16, a base station may transmit sidelink (SL) configuration information to a terminal through signaling (S1601). The SL configuration information may include SL BWP configuration information (e.g., SL-BWP-Config) and/or SL resource pool configuration information (e.g., SL-ResourcePool). The SL BWP configuration information may include information indicating CPE start position(s) (e.g., candidate CPE start position(s)) for S-SSB transmission. The CPE start position(s) (e.g., candidate CPE start position(s)) for S-SSB transmission may be set for each SL BWP. Information indicating the CPE start position(s) for S-SSB transmission may be an index of a set of the CPE start position(s).

The SL resource pool configuration information may include information indicating CPE start position(s) (e.g., candidate CPE start position(s)) for PSFCH transmission and/or CPE start position(s) (e.g., candidate CPE start position(s)) for PSCCH/PSSCH transmission. The CPE start position(s) (e.g., candidate CPE start position(s)) for PSFCH transmission and/or CPE start position(s) (e.g., candidate CPE start position(s)) for PSCCH/PSSCH transmission may be set for each SL resource pool. The information indicating the CPE start position(s) (e.g., candidate CPE start position(s)) for PSFCH transmission may be an index of a set of the CPE start position(s).

The information indicating the CPE start position(s) (e.g., candidate CPE start position(s)) for PSCCH/PSSCH transmission may include information indicating CPE start position(s) (e.g., candidate CPE start position(s)) for PSCCH/PSSCH transmission for COT initiation and/or information indicating CPE start position(s) (e.g., candidate CPE start position(s)) for PSCCH/PSSCH transmission within a COT. The information indicating the CPE start position(s) (e.g., candidate CPE start position(s)) for PSCCH/PSSCH transmission for COT initiation may include a list of CPE start position(s) (e.g., candidate CPE start position(s)) for PSCCH/PSSCH transmission for COT initiation and/or information of a default CPE start position for PSCCH/PSSCH transmission for COT initiation. The list of the CPE start position(s) (e.g., candidate CPE start position(s)) for PSCCH/PSSCH transmission for COT initiation may include the CPE start position(s) and a priority (e.g., L1-priority). The CPE start position(s) (e.g., candidate CPE start position(s)) belonging to the list of the CPE start position(s) (e.g., candidate CPE start position(s)) for PSCCH/PSSCH transmission for COT initiation may be associated with the priority (e.g., L1-priority).

The information indicating the CPE start position(s) (e.g., candidate CPE start position(s)) for PSCCH/PSSCH transmission within a COT may include a list of CPE start position(s) (e.g., candidate CPE start position(s)) for PSCCH/PSSCH transmission within a COT and/or information of a default CPE start position for PSCCH/PSSCH transmission within a COT. The list of the CPE start position(s) (e.g., candidate CPE start position(s)) for PSCCH/PSSCH transmission within a COT may include the CPE start position(s) and a priority (e.g., L1-priority). The CPE start position(s) (e.g., candidate CPE start position(s)) belonging to the list of the CPE start position(s) (e.g., candidate CPE start position(s)) for PSCCH/PSSCH transmission within a COT may be associated with the priority (e.g., L1-priority).

The information indicating the CPE start position(s) may correspond to an index (i) defined in Table 3 below. μ may indicate a numerology. In other words, μ may indicate the SCS. Table 3 may be preconfigured in the base station and/or terminal. The terminal may identify variables (e.g., Cᵢ and Δᵢ) corresponding to each index (i) in Table 3 below, and determine the length of the CPE based on the variables (e.g., Cᵢ and Δᵢ), and determine the CPE start position based on the length of the CPE.

TABLE 3

| | μ = 0 | | μ = 1 | | μ = 2 | |
|---|---|---|---|---|---|---|
| Index (i) | Cᵢ | Δᵢ | Cᵢ | Δᵢ | Cᵢ | Δᵢ |
| 0 | — | — | — | — | — | — |
| 1 | 1 | 16 · 10⁻⁶ | 1 | 16 · 10⁻⁶ | 1 | 16 · 10⁻⁶ |
| 2 | 1 | 25 · 10⁻⁶ | 1 | 25 · 10⁻⁶ | 2 | 16 · 10⁻⁶ |
| 3 | 1 | 34 · 10⁻⁶ | 2 | 16 · 10⁻⁶ | 2 | 25 · 10⁻⁶ |
| 4 | 1 | 43 · 10⁻⁶ | 2 | 25 · 10⁻⁶ | — | — |
| 5 | 1 | 52 · 10⁻⁶ | 2 | 34 · 10⁻⁶ | — | — |
| 6 | 1 | 61 · 10⁻⁶ | 2 | 43 · 10⁻⁶ | — | — |
| 7 | — | — | 2 | 52 · 10⁻⁶ | — | — |
| 8 | — | — | 2 | 61 · 10⁻⁶ | — | — |

The terminal may receive the SL configuration information from the base station and identify the SL BWP configuration information and/or SL resource pool configuration information included in the SL configuration information. The terminal may identify the information indicating the CPE start position(s) (e.g., candidate CPE start position(s)) included in the SL BWP configuration information and/or SL resource pool configuration information (S1602). The information indicating CPE start position(s) (e.g., candidate CPE start position(s)) may be referred to as ‘CPE information’. The information indicating CPE start position(s) (e.g., candidate CPE start position(s)) may include at least one of information indicating the CPE start position(s) (e.g., candidate CPE start position(s)) for S-SSB transmission, information indicating CPE start position(s) (e.g., candidate CPE start position(s)) for PSFCH transmission, or information indicating CPE start position(s) (e.g., candidate CPE start position(s)) for PSCCH/PSSCH transmission.

The terminal may determine a CPE start position based on the information indicating CPE start position(s) (e.g., candidate CPE start position(s)), and may configure a CPE based on the CPE start position (S1603). The terminal may apply the CPE to the first symbol of a signal and/or channel. The CPE may be configured in one or two symbols before the first symbol of the signal and/or channel. The terminal may perform SL transmission including the CPE (S1604). In other words, the terminal may transmit both the CPE and the signal and/or channel. The SL transmission may include at least one of S-SSB transmission, PSCCH transmission, PSSCH transmission, or PSFCH transmission.

In S-SSB transmission, the terminal may determine a start position of the CPE based on the information (e.g., index in Table 3) indicating CPE start position(s) (e.g., candidate CPE start position(s)) for S-SSB transmission. When multiple CPE start positions are indicated to the terminal, the terminal may randomly select one CPE start position among the multiple CPE start positions. The terminal may apply the CPE to the first symbol of an S-SSB based on the CPE start position. The terminal may transmit the S-SSB including the CPE.

In PSFCH transmission, the terminal may determine a start position of the CPE based on the information (e.g., index in Table 3) indicating CPE start position(s) (e.g., candidate CPE start position(s)) for PSFCH transmission. When multiple CPE start positions are indicated to the terminal, the terminal may randomly select one CPE start position among the multiple CPE start positions. The terminal may apply the CPE to the first symbol of a PSFCH based on the CPE start position. The terminal may transmit the PSFCH including the CPE.

In PSCCH transmission and/or PSSCH transmission, if the terminal initiates a COT, and a list of CPE start position(s) (e.g., candidate CPE start position(s)) for PSCCH/PSSCH transmission for COT initiation is configured to the terminal, or if the terminal initiates a COT, and a list of CPE start position(s) (e.g., candidate CPE start position(s)) for PSCCH/PSSCH transmission for COT initiation and information on a default CPE start position for PSCCH/PSSCH transmission for COT initiation are configured to the terminal, the terminal may determine a start time of the CPE based on the list of CPE start position(s) (e.g., candidate CPE start position(s)) for PSCCH/PSSCH transmission for COT initiation. If the list includes multiple CPE start positions (e.g., multiple candidate CPE start positions), the terminal may randomly select one CPE start position from among the multiple CPE start positions. The terminal may apply the CPE to the first symbol of a PSCCH and/or PSSCH based on the CPE start position. The terminal may perform transmission of the PSCCH including the CPE and/or transmission of the PSSCH including the CPE. The PSCCH transmission and/or the PSSCH transmission may be performed to initiate a COT.

In PSCCH transmission and/or PSSCH transmission, if the terminal initiates a COT and information on a default CPE start position for PSCCH/PSSCH transmission for COT initiation is configured to the terminal, the terminal may determine a CPE start position based on the information on the default CPE start position for PSCCH/PSSCH transmission for COT initiation. In other words, if a list of CPE start position(s) (e.g., candidate CPE start position(s)) for PSCCH/PSSCH transmission for COT initiation is not configured to the terminal, and the information on the default CPE start position for PSCCH/PSSCH transmission for COT initiation is configured to the terminal, the terminal may determine a start position of the CPE based on the information on the default CPE start position for PSCCH/PSSCH transmission for COT initiation. The information on the default CPE start position for PSCCH/PSSCH transmission for COT initiation may indicate one default CPE start position. The terminal may apply a CPE to the first symbol of a PSCCH and/or PSSCH based on the CPE start position. The terminal may perform transmission of the PSCCH including the CPE and/or transmission of the PSSCH including the CPE. The PSCCH transmission and/or the PSSCH transmission may be performed to initiate a COT.

In PSCCH transmission and/or PSSCH transmission, if the terminal performs PSCCH transmission and/or PSSCH transmission within a COT, and a list of CPE start position(s) (e.g., candidate CPE start position(s)) for PSCCH/PSSCH transmission within a COT is configured to the terminal, or if the terminal performs PSCCH transmission and/or PSSCH transmission within a COT, and a list of CPE start position(s) (e.g., candidate CPE start position(s)) for PSCCH/PSSCH transmission within a COT and information on a default CPE start position for PSCCH/PSSCH transmission within a COT are configured to the terminal, the terminal may determine a start position of the CPE based on the list of CPE start position(s) (e.g., candidate CPE start position(s)) for PSCCH/PSSCH transmission within a COT. If the list includes multiple CPE start positions (e.g., multiple candidate CPE start positions), the terminal may randomly select one CPE start position from among the multiple CPE start positions. The terminal may apply a CPE to the first symbol of a PSCCH and/or PSSCH based on the CPE start position. The terminal may perform transmission of the PSCCH including the CPE and/or transmission of the PSSCH including the CPE within the COT.

In PSCCH transmission and/or PSSCH transmission, if the terminal performs PSCCH transmission and/or PSSCH transmission within a COT, and information on a default CPE start position for PSCCH/PSSCH transmission within a COT is configured to the terminal, the terminal may determine a start position of the CPE based on information on the default CPE start position for PSCCH/PSSCH transmission within a COT. In other words, if a list of CPE start position(s) (e.g., candidate CPE start position(s)) for PSCCH/PSSCH transmission within a COT is not configured to the terminal, and the information on the default CPE start position for PSCCH/PSSCH transmission within a COT is configured to the terminal, the terminal may determine a start position of the CPE based on the information on the default CPE start position for PSCCH/PSSCH transmission within a COT. The information on the default CPE start position for PSCCH/PSSCH transmission within a COT may indicate one default CPE start position. The terminal may apply a CPE to the first symbol of a PSCCH and/or PSSCH based on the CPE start position. The terminal may perform transmission of the PSCCH including the CPE and/or transmission of the PSSCH including the CPE within the COT.

Hereinafter, a configuration of SL resources will be described. The terminal may receive SL resource configuration information from the base station through a higher layer message (e.g., RRC configuration message). The SL resource configuration information may include start time information of a SL resource and/or length information of the SL resource. The SL resource configuration information may indicate resources available for SL transmission within one slot. The start time information included in the SL resource configuration information may indicate a start time of the SL resource within a slot on a symbol (e.g., OFDM symbol) basis. The length information included in the SL resource configuration information may indicate the length of a time period of the SL resource within a slot in units of symbols (e.g., OFDM symbols). The terminal may perform PSSCH transmission in the SL resource indicated by the base station. The terminal may not perform PSSCH transmission in a time region not indicated as the SL resource.

The terminal may receive start time information of two SL resources consisting of a first start symbol position and a second start symbol position through a higher layer message (e.g., RRC configuration). When the start time information of the two SL resources is indicated (e.g., configured) to the terminal, the terminal may perform SL resource allocation and/or PSSCH transmission using the first start symbol position or the second start symbol position. If there is no PSFCH symbol within the slot, the terminal may perform PSSCH transmission using the first or second start symbol position within the slot.

The terminal may perform a channel access procedure to perform PSSCH transmission at the first start symbol position. If the terminal's channel access procedure fails before the first start symbol position, the terminal may perform PSSCH transmission using the second start symbol position. If the terminal's channel access procedure is successful before the second start symbol position, the terminal may perform PSSCH transmission using the second start symbol position. If the terminal's channel access procedure fails before the second start symbol position, the terminal may not perform PSSCH transmission. In the time domain, the second start symbol position may be later than the first start symbol position.

Hereinafter, a configuration of PSFCH resources will be described. The terminal may receive PSFCH resource configuration information through a higher layer message (e.g., RRC configuration message). The PSFCH resource configuration information may include PSFCH periodicity information. The PSFCH periodicity information may be indicated in slot units. If the PSFCH periodicity information is indicated as 0, it may mean that no PSFCH resource is configured. If the PSFCH periodicity information is indicated as 1, 2, or 4, it may mean that the PSFCH resources are configured at a periodicity of one slot, two slots, or four slots. The terminal may perform PSFCH transmission using the PSFCH resources.

The terminal may perform PSFCH transmission after receiving a PSSCH. The terminal may receive a PSSCH and perform PSFCH transmission after a certain time interval from a reception time of the PSSCH. There may be a minimum value for the time interval between PSSCH reception and PSFCH transmission. A value of the minimum time interval between PSSCH reception and PSFCH transmission may be indicated to the terminal through a higher layer message (e.g., RRC configuration). The terminal may perform PSFCH transmission after the minimum time interval from the reception time of the PSSCH.

The terminal may attempt PSFCH transmission in one or more time periods. The terminal may attempt PSFCH transmission in N slots each including a PSFCH transmission resource. N may be a natural number. The N slots may be configured after the minimum time interval from the reception time of the PSSCH. Information on the N slots may be indicated to the terminal through a higher layer message (e.g., RRC configuration). The terminal may attempt to transmit a PSFCH in chronological order over the indicated N slots. If the terminal succeeds in transmitting the PSFCH, the terminal may not transmit the PSFCH or attempt to transmit the PSFCH in slots following a slot in which the PSFCH transmission has succeeded.

A position at which the PSFCH is transmitted within the slot may vary depending on system configuration. The position at which the PSFCH is transmitted may vary depending on SL resource configuration. The position at which the PSFCH is transmitted may vary depending on the start time of the SL resource and the length of the SL resource. The position at which the PSFCH is transmitted may vary depending on the number of candidate start times of the SL resource. For example, the position at which the PSFCH is transmitted when the number of candidate start times of the SL resource is 1 may be different from the position at which the PSFCH is transmitted when the number of candidate start times of the SL resource is 2. The position at which the PSFCH is transmitted may be indicated by an index of the second OFDM symbol for the PSFCH transmission within the slot.

If the number of candidate start times of the SL resource is 1, the position at which the PSFCH is transmitted within the slot may be determined based on the start position of the SL resource and the length of the SL resource. In an exemplary embodiment, the index of the second OFDM symbol for the PSFCH transmission within the slot may be defined as Equation 1 below.

$$L = start position of SL resource + length of SL resource - two symbols \qquad [ Equation 1 ]$$

If the number of candidate start times of the SL resource is 2, the position at which the PSFCH is transmitted within the slot may be determined based on the first start position of the SL resource and the length of the SL resource. In an exemplary embodiment, the index of the second OFDM symbol for the PSFCH transmission within the slot may be defined as Equation 2 below.

$$L = first start position of SL resource + length of SL resource - two symbols \qquad [ Equation 2 ]$$

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving sidelink (SL) configuration information from a base station;
identifying cyclic prefix extension (CPE) information indicating one or more CPE start positions included in the SL configuration information;
configuring a CPE based on the CPE information; and
performing SL transmission including the CPE.

2. The method of claim 1, wherein the configuring of the CPE based on the CPE information comprises:
in response to the CPE information indicating a plurality of CPE start positions, randomly selecting one CPE start position from among the plurality of CPE start positions; and
configuring the CPE based on the one CPE start position.

3. The method of claim 1, wherein the configuring of the CPE based on the CPE information comprises: applying the CPE to a first symbol of a SL signal or SL channel, and the CPE is located in one or two symbols before the first symbol.

4. The method of claim 1, wherein the SL configuration information includes at least one of CPE information indicating one or more CPE start positions for sidelink-synchronization signal block (S-SSB) transmission, CPE information indicating one or more CPE start positions for physical sidelink feedback channel (PSFCH) transmission, or CPE information indicating one or more CPE start positions for physical sidelink control channel (PSCCH)/physical sidelink shared channel (PSSCH) transmission.

5. The method of claim 4, wherein the performing of the SL transmission including the CPE comprises: performing S-SSB transmission including the CPE determined based on one CPE start position among the one or more CPE start positions for S-SSB transmission.

6. The method of claim 4, wherein the performing of the SL transmission including the CPE comprises: performing PSFCH transmission including the CPE determined based on one CPE start position among the one or more CPE start positions for PSFCH transmission.

7. The method of claim 4, wherein the CPE information indicating one or more CPE start positions for PSCCH/PSSCH transmission includes at least one of CPE information indicating one or more CPE start positions for PSCCH/PSSCH transmission for channel occupancy time (COT) initiation, or CPE information indicating one or more CPE start positions for PSCCH/PSSCH transmission within a COT.

8. The method of claim 7, wherein the CPE information indicating one or more CPE start positions for PSCCH/PSSCH transmission for COT initiation includes at least one of a list of one or more CPE start positions for PSCCH/PSSCH transmission for COT initiation or information on a default CPE start position for PSCCH/PSSCH transmission for COT initiation.

9. The method of claim 8, wherein the list includes the one or more CPE start positions for PSCCH/PSSCH transmission for COT initiation and a priority associated with the one or more CPE start positions for PSCCH/PSSCH transmission for COT initiation.

10. The method of claim 8, wherein when the list of one or more CPE start positions for PSCCH/PSSCH transmission for COT initiation is configured to the terminal, the CPE is configured based on one CPE start position among the one or more CPE start positions belonging to the list, and at least one of PSCCH transmission including the CPE or PSSCH transmission including the CPE is performed for COT initiation.

11. The method of claim 8, wherein when the list of one or more CPE start positions for PSCCH/PSSCH transmission for COT initiation is not configured to the terminal, and the default CPE start position for PSCCH/PSSCH transmission for COT initiation is configured to the terminal, the CPE is configured based on the default CPE start position, and at least one of PSCCH transmission including the CPE or PSSCH transmission including the CPE is performed for COT initiation.

12. The method of claim 7, wherein the CPE information indicating one or more CPE start positions for PSCCH/PSSCH transmission within a COT includes at least one of a list of one or more CPE start positions for PSCCH/PSSCH transmission within a COT or information on a default CPE start position for PSCCH/PSSCH transmission within a COT.

13. The method of claim 12, wherein when the list of one or more CPE start positions for PSCCH/PSSCH transmission within a COT is configured to the terminal, the CPE is configured based on one CPE start position among the one or more CPE start positions belonging to the list, and at least one of PSCCH transmission including the CPE or PSSCH transmission including the CPE is performed within a COT.

14. The method of claim 12, wherein when the list of one or more CPE start positions for PSCCH/PSSCH transmission within a COT is not configured to the terminal, and the default CPE start position for PSCCH/PSSCH transmission within a COT is configured to the terminal, the CPE is configured based on the default CPE start position, and at least one of PSCCH transmission including the CPE or PSSCH transmission including the CPE is performed within a COT.

15. A terminal comprising at least one processor,
wherein the at least one processor causes the terminal to perform:
receiving sidelink (SL) configuration information from a base station;
identifying cyclic prefix extension (CPE) information indicating one or more CPE start positions included in the SL configuration information;
configuring a CPE based on the CPE information; and
performing SL transmission including the CPE.

16. The terminal of claim 15, wherein in the configuring of the CPE based on the CPE information, the at least one processor causes the terminal to perform:
in response to the CPE information indicating a plurality of CPE start positions, randomly selecting one CPE start position from among the plurality of CPE start positions; and
configuring the CPE based on the one CPE start position.

17. The terminal of claim 15, wherein in the configuring of the CPE based on the CPE information, the at least one processor causes the terminal to perform: applying the CPE to a first symbol of a SL signal or SL channel, and the CPE is located in one or two symbols before the first symbol.

18. The terminal of claim 15, wherein the SL configuration information includes at least one of CPE information indicating one or more CPE start positions for sidelink-synchronization signal block (S-SSB) transmission, CPE information indicating one or more CPE start positions for physical sidelink feedback channel (PSFCH) transmission, or CPE information indicating one or more CPE start positions for physical sidelink control channel (PSCCH)/physical sidelink shared channel (PSSCH) transmission.

19. The terminal of claim 18, wherein in the performing of the SL transmission including the CPE, the at least one processor causes the terminal to perform: performing S-SSB transmission including the CPE determined based on one CPE start position among the one or more CPE start positions for S-SSB transmission.

20. The terminal of claim 18, wherein the CPE information indicating one or more CPE start positions for PSCCH/PSSCH transmission includes at least one of CPE information indicating one or more CPE start positions for PSCCH/PSSCH transmission for channel occupancy time (COT) initiation, or CPE information indicating one or more CPE start positions for PSCCH/PSSCH transmission within a COT.
